(19) United States
(12) Patent Application Publication
(10) Pub. No.: US 2013/0201014 A1
(43) Pub. Date: Aug. 8, 2013

(54) Method and Device for Indicating of the Turn-Intention of a Vehicle

(71) Applicant: Alexander Luchinskiy, Bad Kreuznach (DE)

(72) Inventor: Alexander Luchinskiy, Bad Kreuznach (DE)

(21) Appl. No.: 13/709,012

(22) Filed: Dec. 9, 2012

Related U.S. Application Data
(60) Provisional application No. 61/569,176, filed on Dec. 9, 2011.

(30) Foreign Application Priority Data
Dec. 9, 2010 (DE) 10 2010 053 996.1
Nov. 18, 2011 (DE) 10 2011 118 842.1
Dec. 9, 2011 (DE) 10 2011 120 598.9
May 16, 2012 (DE) 10 2012 010 157.0

(51) Int. Cl. B60Q 1/38

(52) U.S. Cl. CPC B60Q 1/38
USPC 340/475

(57) ABSTRACT

Invention provides a more clear recognisable indicating of the maneuvering-intentions of a vehicle to improve the safety of traffic. More appropriate for human eyes way to recognise the turn- and stop-intention signals are provided. It makes it possible to estimate the current traffic situation certain and quickly, in spite of the usual technical obstacles to recognise the signal- and vehicle position (as, for example, in the darkness, a dazzling light of the head lamps of the vehicles which are moving in the opposite direction, or, in the day time, a bright surrounding under the shining sun, or a limited view from the driver seat, etc.).

### CROSS-REFERENCE TO RELATED APPLICATIONS

This application claims the priority benefits to U.S. provisional patent application, Ser. No. 61/569,176 filed Dec. 9, 2011, to German patent application DE 10 2010 053 996.1, filed Dec. 9, 2010, to German patent application DE 10 2011 118 842.1, filed Nov. 18, 2011, to German patent application DE 10 2011 120 598.9, filed Dec. 9, 2011, to German patent application DE 10 2012 010 157.0, filed May 16, 2012.

### STATEMENT REGARDING FEDERALLY SPONSORED RESEARCH OR DEVELOPMENT

Not Applicable

### REFERENCE TO SEQUENCE LISTING; A TABLE; OR A COMPUTER PROGRAM LISTING COMPACT DISC APPENDIX

Not Applicable

### BACKGROUND OF THE INVENTION

(1) Field of the Invention

The present invention relates to vehicle signal lighting.

(2) Description of Related Art

The light-signals of a vehicle are generally known, which signals indicate the intentions of a driver to execute any manoeuvre. To these signals belong the signals “turn on right or on left”, “stop”, “further motion”.

The shortcoming of this a.m. method and devices is an essential limitation of the detectability of these signals, especially from the front side in the darkness, because the head lamps lighting (beaming) much more bright, then the relatively dim (dull) turn-intention light signals. Besides, also under the shining sun, the a.m. turn-intention light signals are relatively difficult detectable against the background of bright surrounding.

### BRIEF SUMMARY OF THE INVENTION

Aim of the presented invention is to provide a more clear and easy & quick recognisable indicating of the maneuvering-intentions of a vehicle and therewith to improve the safety of traffic. This problem is solved in the listed in the claims features.

The attained by this invention advantages are, in particular, that it makes it possible to recognise the current traffic situation (situation with the vehicles in the road) certain and quickly, in spite of the usual technical obstacles to recognise the signal- and vehicle position (as, for example, in the darkness, a dazzling light of the head lamps of the vehicles which are moving in the opposite direction, or, in the day time, a bright surrounding under the shining sun, or a limited view from the driver seat, etc.).

### BRIEF DESCRIPTION OF THE SEVERAL VIEWS OF THE DRAWINGS

The examples of embodiment of the invention are presented in the drawings and described below.

The figures show:

FIG. 1-FIG. 3: Schematical representation, how looks the front view of a vehicle from the point of view of a driver, who seats in a vehicle, which moves in the opposite direction; FIG. 1—without turn-indicating blinking lamps (Blinker); FIG. 2—with a switched-on right turn-indicating lamp (lights); FIG. 3—with a switched-on left turn-indicating lamp (lights);

FIG. 4(A-C)-FIG. 7: Possible embodiments of the Arrow-kind structure of a turn-indicating-signal lighting of a vehicle:

FIG. 4A and FIG. 4C—possible embodiment of the Arrow-kind structure, where FIG. 4A is a front view with a switched-on right turn, FIG. 4B—the same view with a schematic presentation of the Arrow-kind structure, and FIG. 4C is the same view with a switched-on left turn;

FIG. 5A and FIG. 5B—possible embodiment, where FIG. 5A is one axonometric view of a vehicle, with a shown plane of symmetry, and FIG. 5B is the same view with the switched-on right turn indication;

FIG. 6A and FIG. 6B—the same embodiment, where FIG. 6A is one other axonometric view of the vehicle, with a shown plane of symmetry, and FIG. 5B is this same view with the switched-on left turn indication;

FIG. 7—possible Head-Part- and Foot-Part-embodiments of the Arrow-kind structure.

FIG. 8A and FIG. 8B: Possible different variants of the placing (positioning) of the arrow-kind turn-indicating-signal lights of a vehicle: FIG. 8A—front view, FIG. 8B—side view.

FIG. 9: The most probable variants of combinations of the placing (positioning) of the lightlines.

FIG. 10A and FIG. 10B: Possible variant of the placing of an arrow-kind turn-indicating-signal lights of a vehicle on the back side of a vehicle: FIG. 10A—back view with the switched-on left turn; FIG. 10B—the same view with the switched-on right turn.

FIG. 11A and FIG. 11B: Possible variant of embodiment of turn-indicators: FIG. 11A—front view with the switched-on right turn; FIG. 10B—the same view with the switched-on left turn.

FIG. 12(A-C)-FIG. 19(A-C): Examples of embodiments of the reflection-kind indicating of a turn-intention:

FIG. 12(A-C): front view of the vehicles with the turn-indicator lights, beaming down in the shadow area under the vehicle, where FIG. 12A—general schematic front view; FIG. 12B—the same view in the dark; FIG. 12C—the same view under the bright sun;

FIG. 13: front view of the vehicles with the turn-indicator lights, beaming down both in the shadow area under the vehicle and also down near the vehicle;

FIG. 14(A-C): front view of the vehicles with the turn-indicator lights, beaming down both in the shadow road area under the vehicle and also to the internal part of either left or right wheel of the vehicle, where FIG. 14A—general schematic front view, FIG. 14B—the same view in the dark; FIG. 14C—the same view under the bright sun;

FIG. 15: possible variants of synchronising between the light-flashing lamp (lighting) and usual turn-intention lighting in the same vehicle;

FIG. 16: one possible placing of the down-beaming lights (beamers) under a vehicle;

FIG. 17: one possible placing of the down-beaming lights (beamers) under a vehicle;

FIG. 18(A-C): one possible placing of the down-beaming lights (beamers) under a vehicle, where FIG. 18A—axonometric view, FIG. 18B—partial front view of the same vehicle with the switched-on right turn, FIG. 18C—the same front view with the switched-on left turn;

FIG. 19(A-C): one possible placing of the down-beaming lights (beamers) on edges of a vehicle, where FIG. 19A—axonometric view, FIG. 19B—partial front view of the same vehicle with the switched-on right turn, FIG. 19C—the same front view with the switched-on left turn.

FIG. 20A and FIG. 20B: Possible variant of a head-lighting (head lamp) embodiment, where FIG. 20A—front view; FIG. 20B—side view.

FIG. 21: Possible variant of embodiment of a stop-indicator.

FIG. 22-FIG. 30: Possible variants of placing of lightlines

FIG. 31A and FIG. 31B: Possible variant of placing of turn-indicating lights, where FIG. 31A—front view; FIG. 31B—side view.

FIG. 32A and FIG. 32B: Possible variant of placing of turn-indicating lights, where FIG. 32A—front view; FIG. 32B—side view.

FIG. 33A and FIG. 33B: Possible variant of placing of turn-indicating lights, where FIG. 33A—front view; FIG. 33B—side view.

FIG. 34A and FIG. 34B: Possible variant of placing of a video-scout, where FIG. 34A—front view; FIG. 34B—side view.

FIG. 35—Video-scout with a telescopic support for videocamera.

FIG. 36—Video-scout with an adjustable for different angles in respect to the vehicle's body support for videocamera.

### DETAILED DESCRIPTION OF THE INVENTION

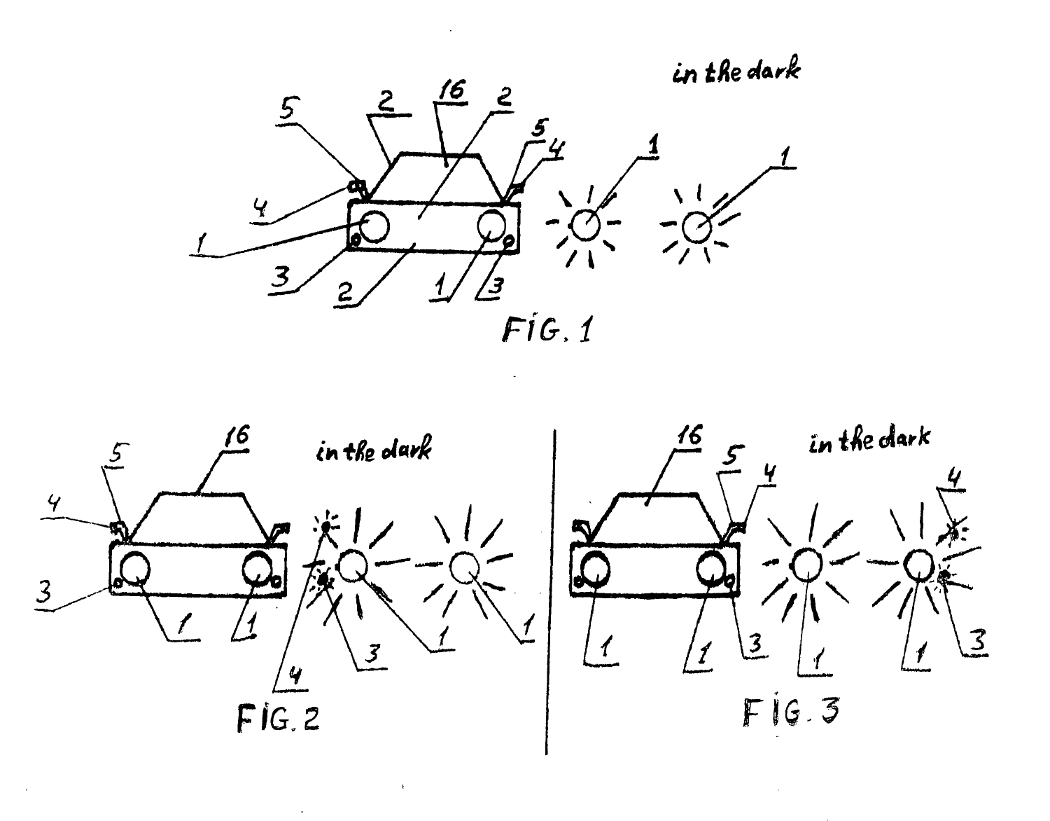

FIG. 1 shows schematically, how looks from the front view in the darkness a vehicle without the switched-on turn-indicating lights, from the point of view of the driver of the vehicle, which moves in the opposite direction. As in the darkness there is a big and sharp difference of a light intensity between the light, which goes from head lamps surfaces 1 and from the surface of a vehicle body 2, a driver, who moves from the opposite directions, see only two schining surfaces of the head lamps 1. The turn-indicating lights (lamps) 3 (FIG. 2 and FIG. 3), which are placed near the head lamps 1, are also less bright shining, then the head lamps 1. Therefor these turn-indicating lamps are basically bad recognisable. One recognises them more or less sure only 1) (main reason) because of the blinking working regime of this lights, 2) because the car body is equipped also with the other additional side-turn-indicating lights 4, which are placed on the left (or right) side of the vehicle body, or on the right & left rear-view mirror 5, and additionally 3) because these turn-indicating lights have normally the red shining color in comparison the white (all-spectrum) shining color of the vehicle head lamps.

To improve the recognisability of the turn-indicating signals, it is possible to indicate a turn-intention of a vehicle 16 by an arrow-kind lighting structure, which one is good recognisable also near an in spite of the brightly shining vehicle's head lamps.

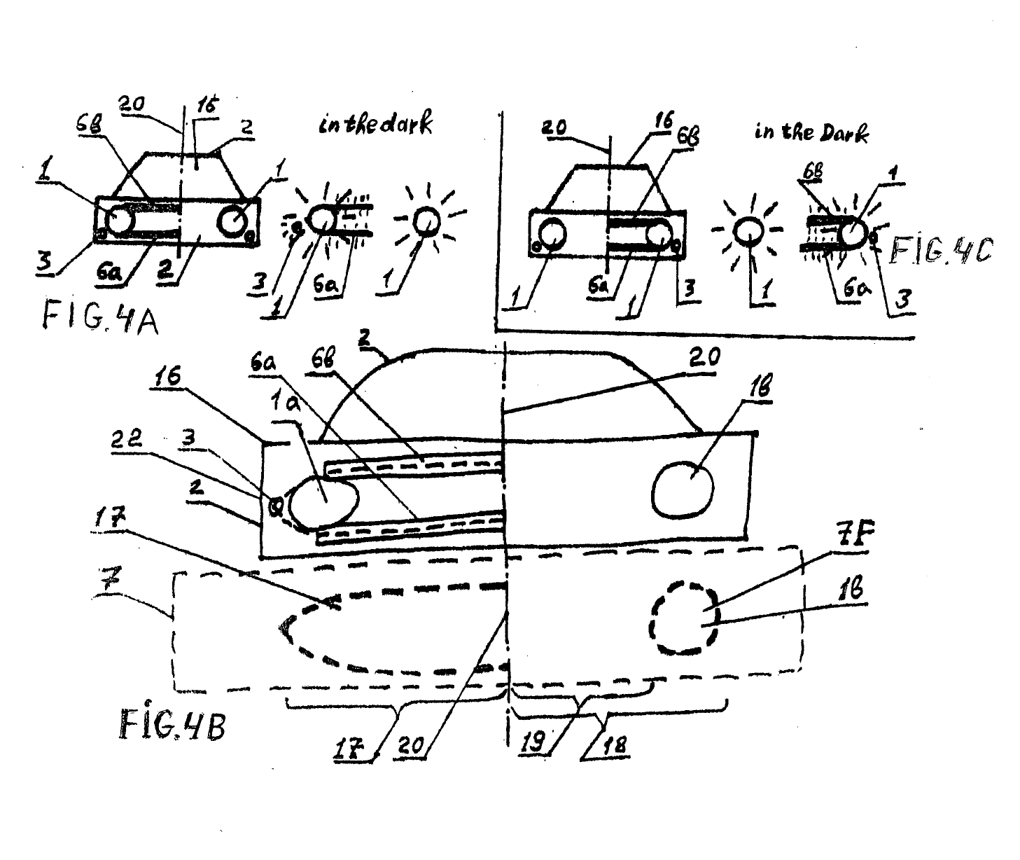

FIG. 4A, FIG. 4B and FIG. 4C shows schematically one possible variant of embodiment of this arrow-kind lighting. The lighting lines (or lighting strips) 6, among others (a.o.) 6a-6z, (in the future called as “lightlines”) are forming an easy recognisable (also easy recognisable from the front view in the darkness) arrow-kind lighting structure 7, together with the head lamp 1a and with the nearby placed usual turn-indicating lamp 3. The second, separately shining head lamp 1b is forming a placed on the some certain distance “foot” 7F of the arrow, and this way this head lamp also belongs to the lighting structure 7. (Here is presented only the turn-indication on-right; the turn-indication on-left is full-symmetrical, and therefore it is not presented).

Therewith the arrow-kind turn-indicating lighting structure 7 contains two parts:
1) a head-part 17, which one is formed by the switched-on (a.o. blinking) lightlines 6. This head-part can also contain the blinking turn-indicating lamps 3 or 5 and a permanently (not-blinking) shining head lamp 1a;
2) a foot-part 18, which one is formed by the permanently (not blinking) shining head lamp 1b (i.e. “foot” 7F) and by the dark interval 19 between this head lamp 1b (foot 7F) and the axis of symmetry 20. (Or with another words, the head lamp 1b forms a placed on a definite distance “foot” 7F of the arrow, and therewith the foot-part 18 contains a permanently (not blinking) shining head lamp 1b and dark space (interval) 19 between this head lamp and axis of symmetry 20 of the vehicle.)

This way the direction of the orientation of the arrow is easy recognisable. The both head lamps are the parts of these arrow-kind lighting structure 7. Therefor the light of head lamps does not interfere (does not disturb), but in the opposite, helps to recognise the turn-indication signaling.

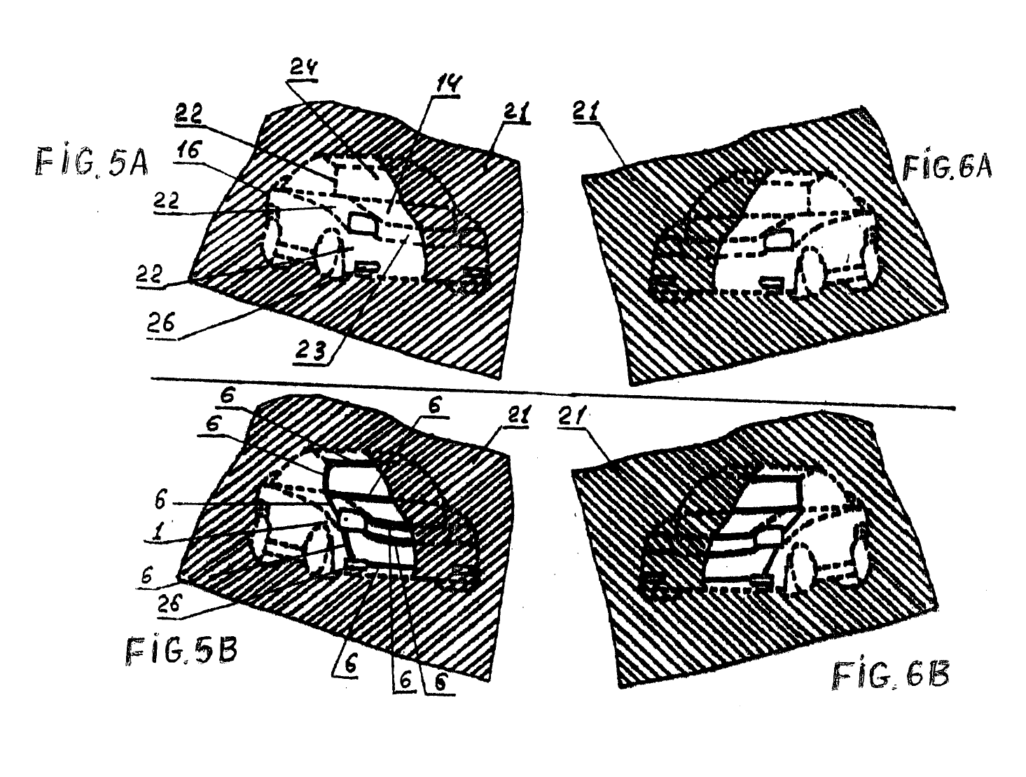

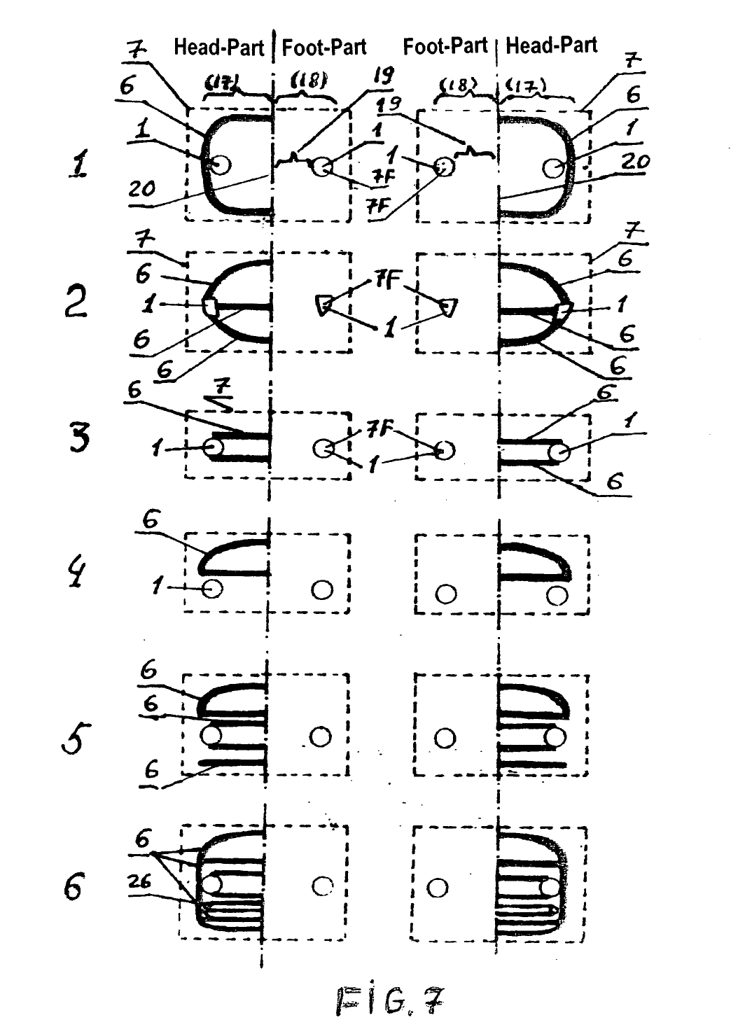

Each pair of the lightlines 6 is symmetrical relatively the plane of symmetry 21 of the vehicle 16 (FIG. 5A & FIG. 5B and FIG. 6A & FIG. 6B). Each pair consist of the two (one left-placed and one right-placed) lightlines 6, which lightlines indicate (show) the turn-intention of the vehicle 16.

And to be more precise, this FIG. 5A & FIG. 5B and FIG. 6A & FIG. 6B presents schematically several possible placing of the lighting lines 6 relatively to the plane of symmetry 21 (different variants simultaneously in one picture), and more concretely: FIG. 5B—a vehicle with the electrically switched-on turn-indication on-right; and FIG. 6B—a vehicle with the electrically switched-on turn-indication on-left.

Therewith the turn-indicating lighting of a vehicle 16 contains at least one pair of the lighting-able lines 6.
Where these above mentioned (a.m.) two lines 6 are symmetrical one to another relatively the plane of symmetry 21 of this vehicle 16. (I.e. the plane of symmetry of this vehicle is the plane of symmetry of these two lines, and therewith the axis of symmetry 20 of the front view (or back view) of this vehicle is the axis of symmetry of the front view (or back view) of these a.m. lines.)
Besides, these two lines has the separate, independent one from another, electrical connection.
Besides, these a.m. two lines begin themselves in one common point, which point lays on the axis of symmetry 20 of the front view (or back view) of this vehicle, and after that these two a.m. lines go from this point correspondently on-left and on-right from this axis of symmetry; after that these a.m. two lines go up to (or approximately up to) the extremely left part of the external contour 22 of the vehicle and the extremely right part of the external contour of the vehicle correspondently. And after that, a.o. (among other variants), the a.m. lines can further go on, along the external contour of the correspondently left and right external contours (silhouettes) 22 of the vehicle; and after that these a.m. two lines go back to the a.m. axis of symmetry, and these lines are ending themselves in some common point on this axis of symmetry.

Or, instead of the a.m. extremely left (right) parts of the external contour 22 of the vehicle, these a.m. two lines can go up to the left (right) part of some geometrical peculiarity (feature) of the vehicle body, and after that these lines can further go along this peculiarity.

One of these a.m. two lines is shining (is lighting) during the turn-indicating, and the second one from these two lines is not switched on during this time period.

Therewith the switched-on lighting line embraces (surrounds) the external contour (Silhouette) of this vehicle, and concretely from that side of the axis of symmetry, whereto the turn-intention is intended and indicated. Whereby a.o. these lighting lines can embrace (surround) the external contour (Silhouette) of only one part of a vehicle (as f.e. radiator 23, front window (back window) 24, motor hood 14, deck lid (luggage rack, boot) (or back door) 25, etc.), also from that side of the axis of symmetry 20, whereto the turn-intention is intended and indicated. Or one can use not only one pair of the a.m. lightlines 6, but to use several/numerous pairs of the lighting-able lines 6 simultaneously.

Each of the a.m. two lighting-able lines, which belong to the same a.m. pair, can begin themselves approximately on the axis of symmetry and end themselves approximately on the extremely left (or right correspondently) part of the external contour of a vehicle.

Each of the a.m. two lighting-able lines, which belong to the same a.m. pair, can also begin themselves approximately on the axis of symmetry and to end themselves approximately on the left (or right correspondently) usual light source (among others head lamp 1, turn-indicating lamp 3 or 5, etc.) of the vehicle 16.

And besides all these lighting lines a.o. can be also discontinuous.

The lightlines 6 can also blink, a.o. also blink together and synchron with the usual turn-intention lighting lamps 3. Or the lightlines 6 can shine (light) such way, that this lighting is formed from the one after another following bright (lighting) and dark spaces (points), where this lighting is controlled electrically such way, that the bright and dark spaces (points) move in the direction of turn-intention. The arrow-kind structure 7 can contain also several/numerous lightlines 6, whereby some of these lines 6 can blink, and the others from these lines 6 simultaneously can show/indicate the turn-intention through the a.m. moving of the bright light spaces/points.

In general the arrow-kind structure 7 is formed from the following most important elements:
1) Curvilinear head-part 17 of the arrow-kind lighting structure 7:
   Die lighting lines, which are lighting (a.o. also blinking lighting) from that side of the plane of symmetry 21 of a vehicle 16, whereto the turn-intention is intended and indicated. To the head of the arrow belong also the such permanently (not blinking) shining lights (a.o. head lamps), which are also placed from the same side of the plane of symmetry. They are normally placed in the top of the curvilinear head of arrow. Also the usual blinking lamp-kind turn-intention indicators (as f.e. lamps 3, 5, etc.) can belong additionally to the head-part 17 of the arrow-kind lighting structure 7.
2) Foot-part 18 of the arrow-kind lighting structure 7 is formed through:
   a) the permanently (not blinking) lighting “Foot”-7F—of the arrow 7, i.e. a head lamp 1, (or also other lights 26, which shine permanently (not blinking way), and which are placed on the vehicle body from the opposite side of the a.m. plane of symmetry 21;
      and
   b) the dark gap 19 between the a.m. foot 7F of the arrow 7 and the axis of symmetry 20 of the vehicle on the front view (back view) of the vehicle.

In reality on see normally either a front view, or a back view of a vehicle, and therefore below will be spoken not about the plane of symmetry 21, but about the axis of symmetry 20 of the front view (or back view).

There always exists an essential dark distance (interval, gap) 19 between the “Foot” 7F of the arrow 7 and the axis of symmetry 20, from which one the curvilinear head-part 17 of the arrow 7 begins itself. On the other hand, the head of the arrow contains long lighting lines, which embrace (surround) or cover a big external contour of the one from the two symmetrical opposite sides of a vehicle. One (either left or right) part of the external contour (silhouette, Ladeprofil) of the vehicle from the left (right) head lamp up to the axis of symmetry 20 remains dark. And the other part of the vehicle (i.e. a right (left) silhouette, immediate from the axis of symmetry up to the right external contour is shining, a.o. also blinking shining, and besides, a.o., it is indicated by the long lighting lines. Therefore this lighting structure 7 is easy recognisable.

Some possible variants of embodiments of the arrow-kind lighting structure 7 is presented a.o. in FIG. 7 (both for the left and for the right turn-intentions). These arrow-kind structures 7 are presented, nevertheless, also in others figures in this description, actually everywhere, where one shows schematically the views “in the Darkness”.

The lighting lines 6 are placed outside the head lamps, and concretely either on the vehicle body 2 or on (or behind of) the windows 24 of the vehicle. (One cannot place effectively any additional lights under the transparent cover of a head lamp 1, because these additional lights could be practically bad recognisable against the bright shining background of the head lamp.) The lighting lines 6 are long; their lengths are comparable with the external dimensions of the vehicle, on which one these lines are installed. Therefore a human eye recognises surely these lines against the background of a vehicle's body with the brightly shining head lamps and back lamps.

This way one shows the turn-intention not by some point-kind (it means among others (a.o.) round, quadrangular, etc.) little lamps, but by an arrow-kind lighting structure, which one has the same (or comparable) dimensions with the dimensions of the vehicle. Besides, this arrow-kind lighting structure contains both the permanently (not blinking) shining head- and back lamps 1, and also the lighting (a.o. also blinking lighting) lines 6.

In some embodiments the lightlines 6 can irradiate a diffusive (scattered, dispersal) light. But in other embodiments these lightlines 6 can also irradiate a shining beam-kind (a.o. also a shining perpendicularly to the lightline or to the vehicle body) light.

Or the same lightline can also be lighting-able in the both a.m. modes: either in a diffusive light-mode (f.e. in the darkness), or in a shining (beam-kind) light-mode (f.e. in the sun weather). Such way the same lightline 6 can be not-dazzling in a darkness, but be good recognisable in a sun weather.

For the lightlines 6 one can use light sources, which work on all possible physical principles, a.o. also the LED-kind light sources.

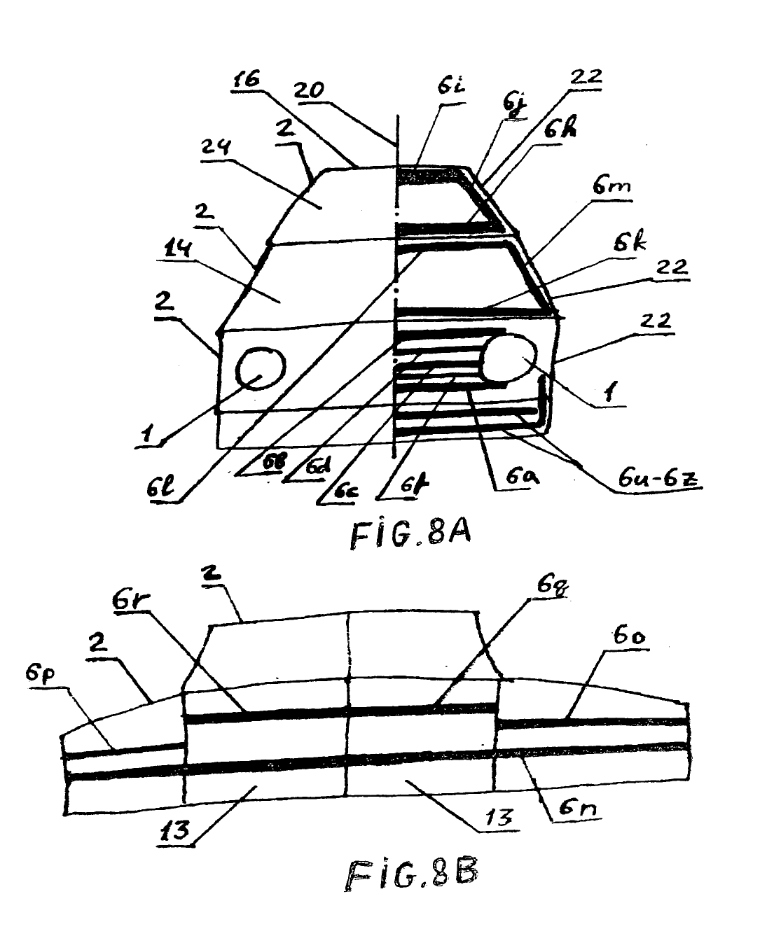

FIG. 8A (front view) and FIG. 8B (side view) shows schematically some examples—variants of the placing of the lightlines 6 to attain the easy recognisable turn-signalling, and, among others, to realise the arrow-kind turn-signal lighting of a vehicle. All lightlines are shown only on one side of a vehicle, and concretely for the case, when a vehicle have to show a turn-intention on the left. The possible variants for the turning on the right are absolutely symmetrical, and therefore these variants are not shown. The realisation (embodiment) variants for the back lighting are the same, as also for the above described front lighting, and therefore these variants are also not shown.

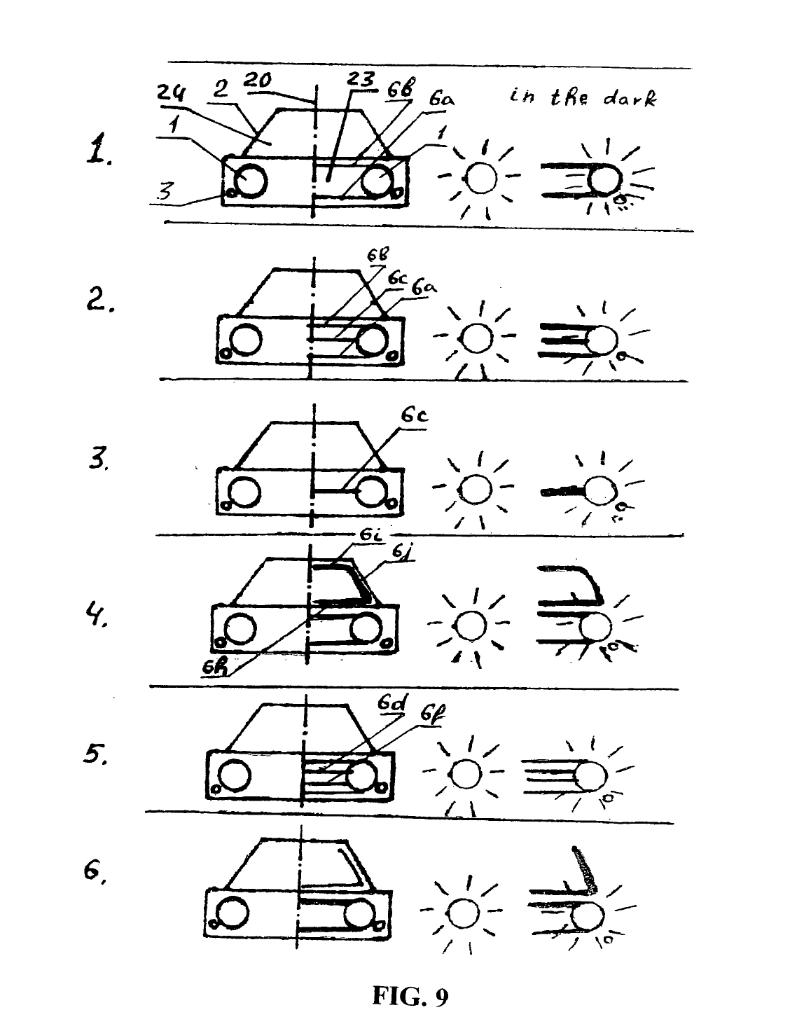

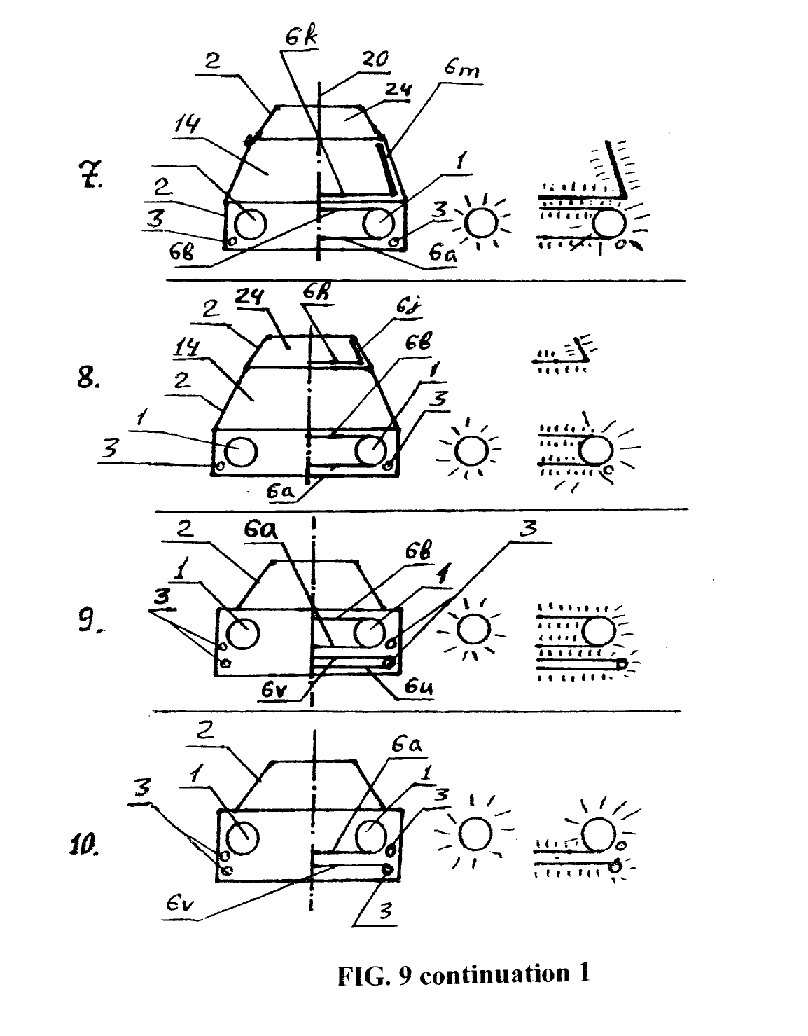

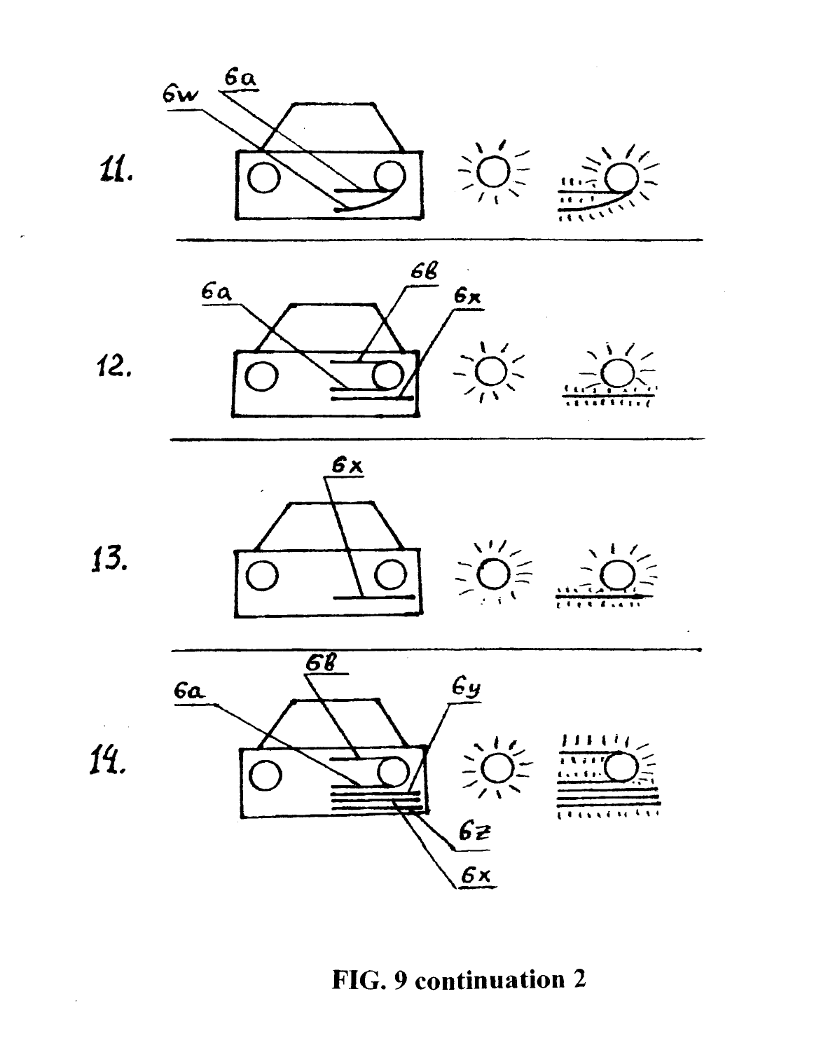

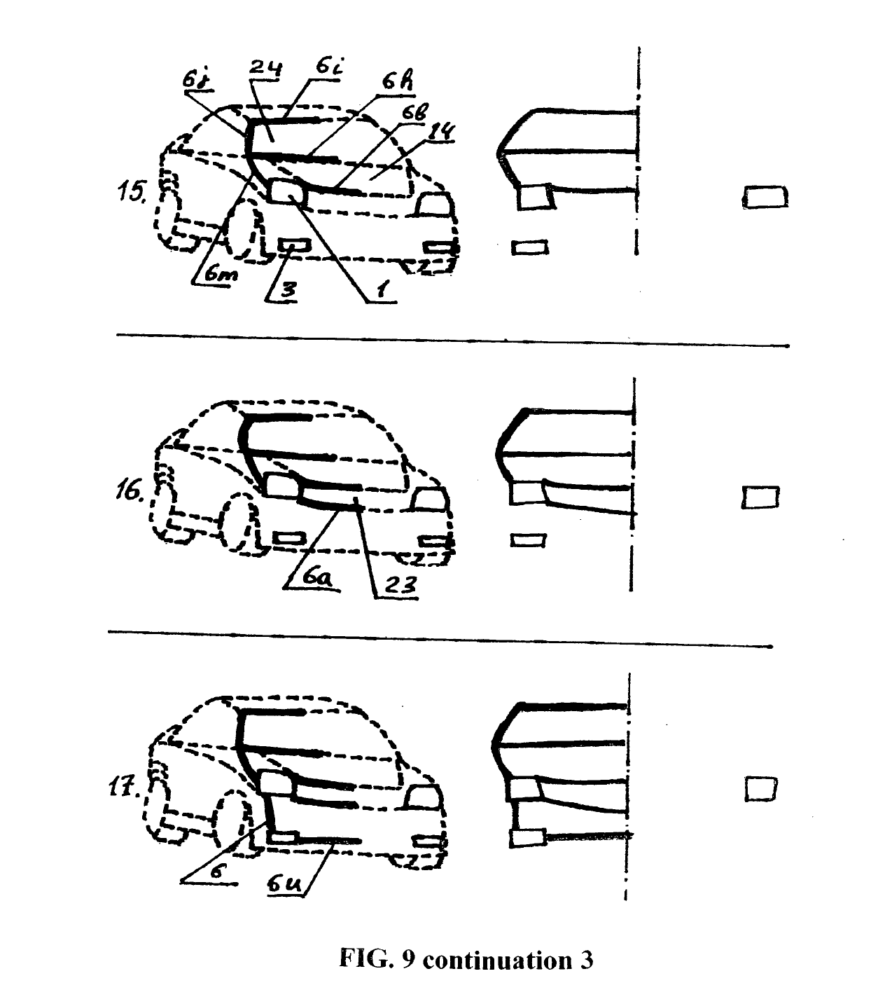

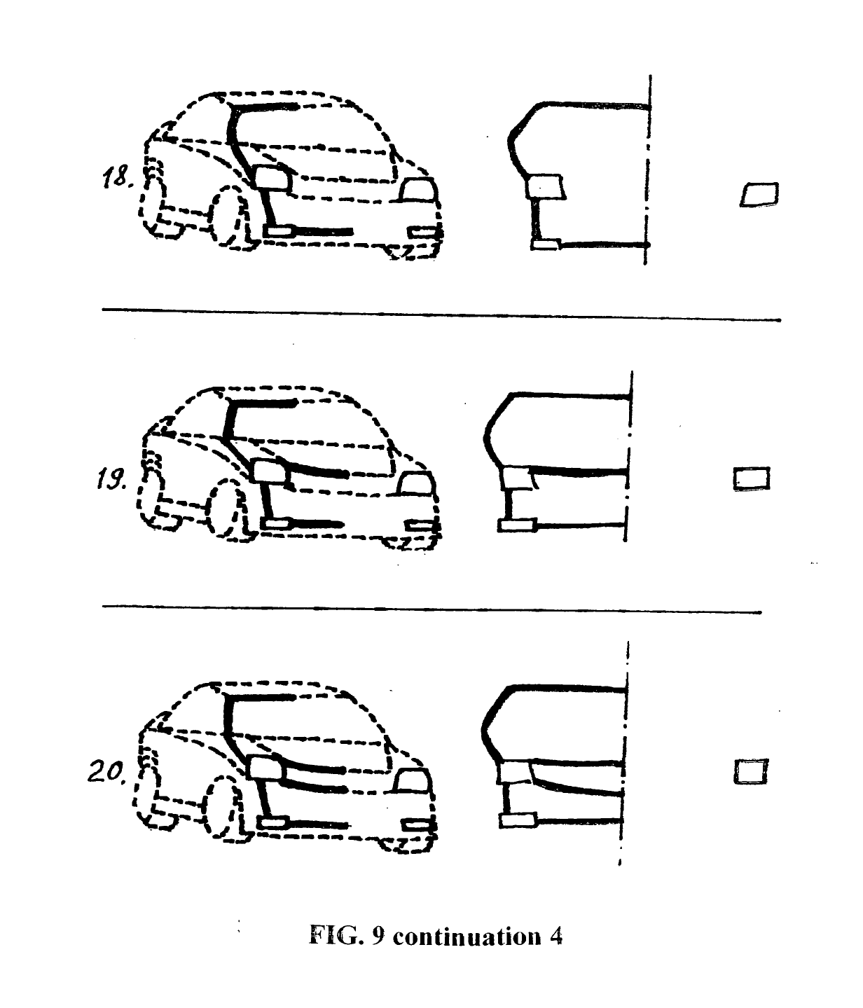

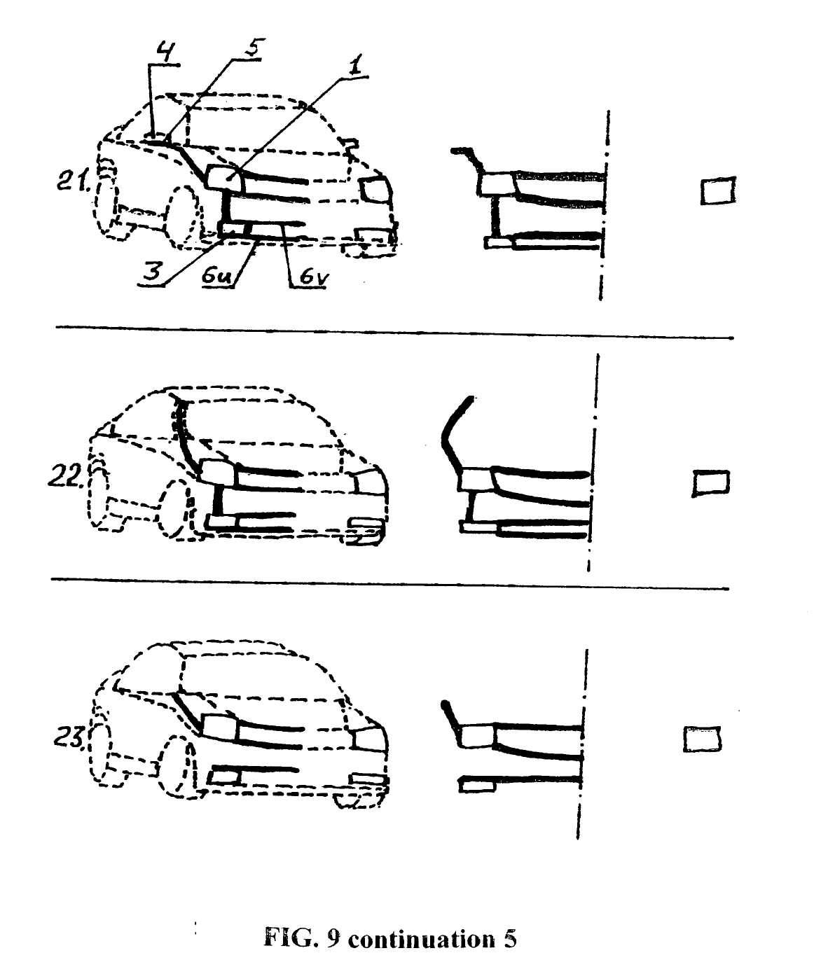

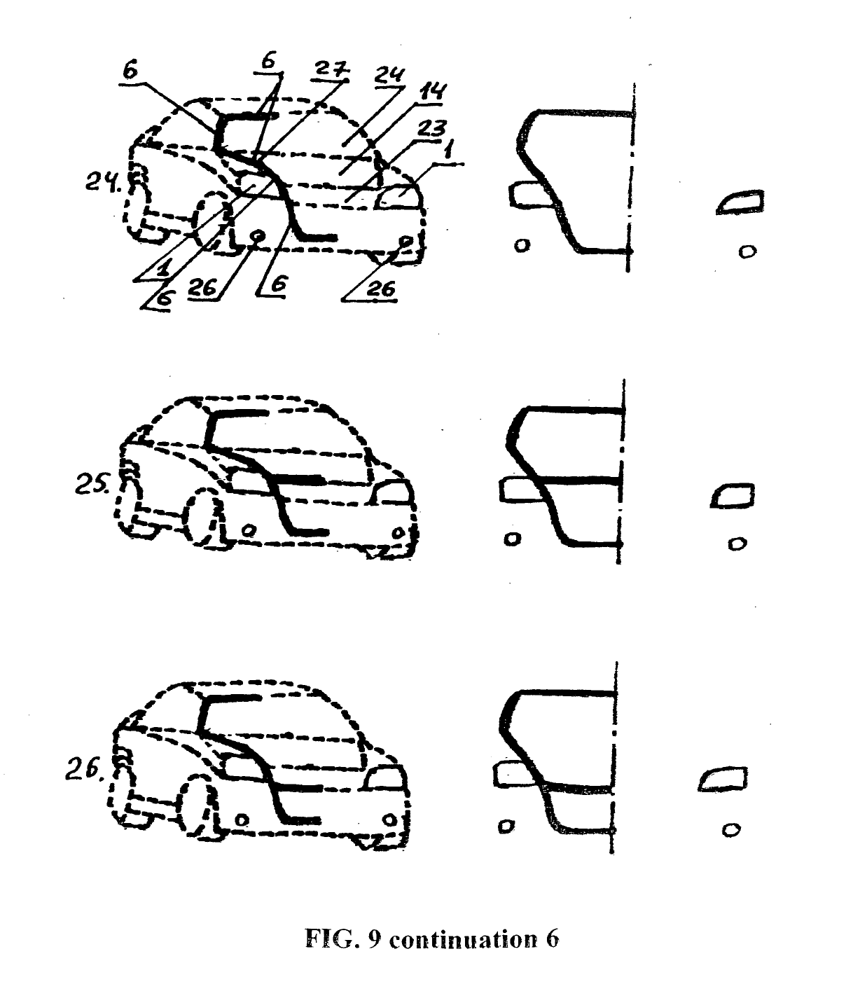

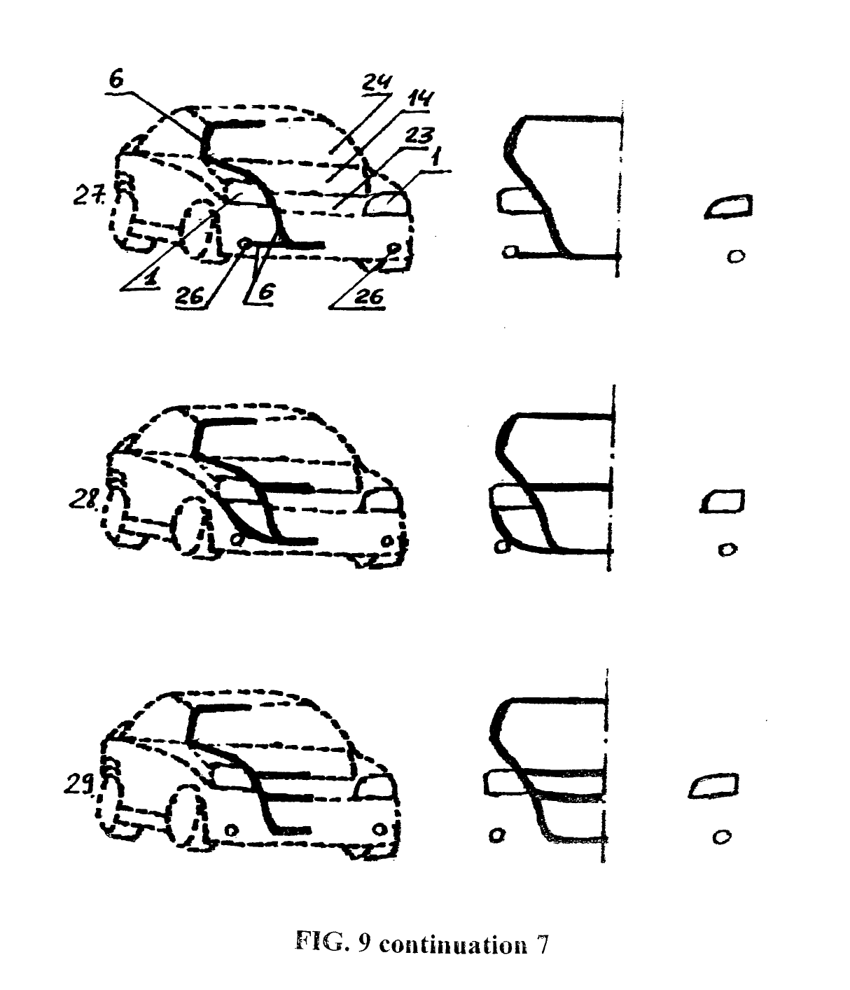

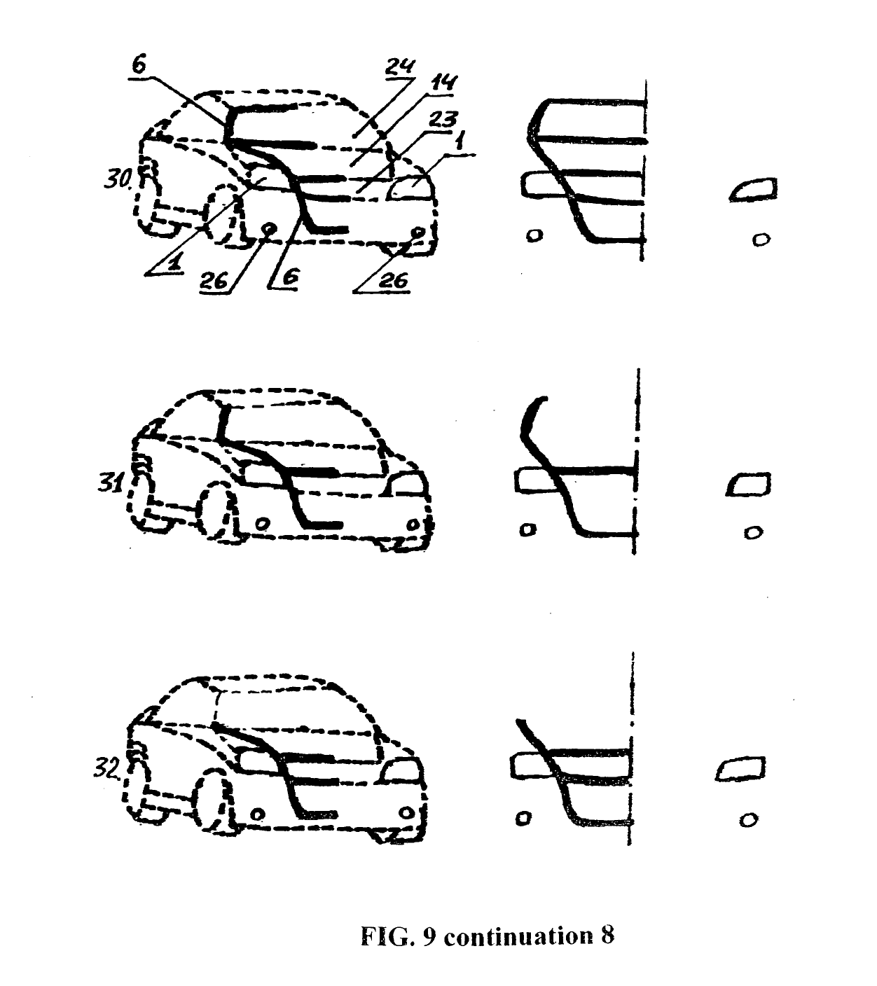

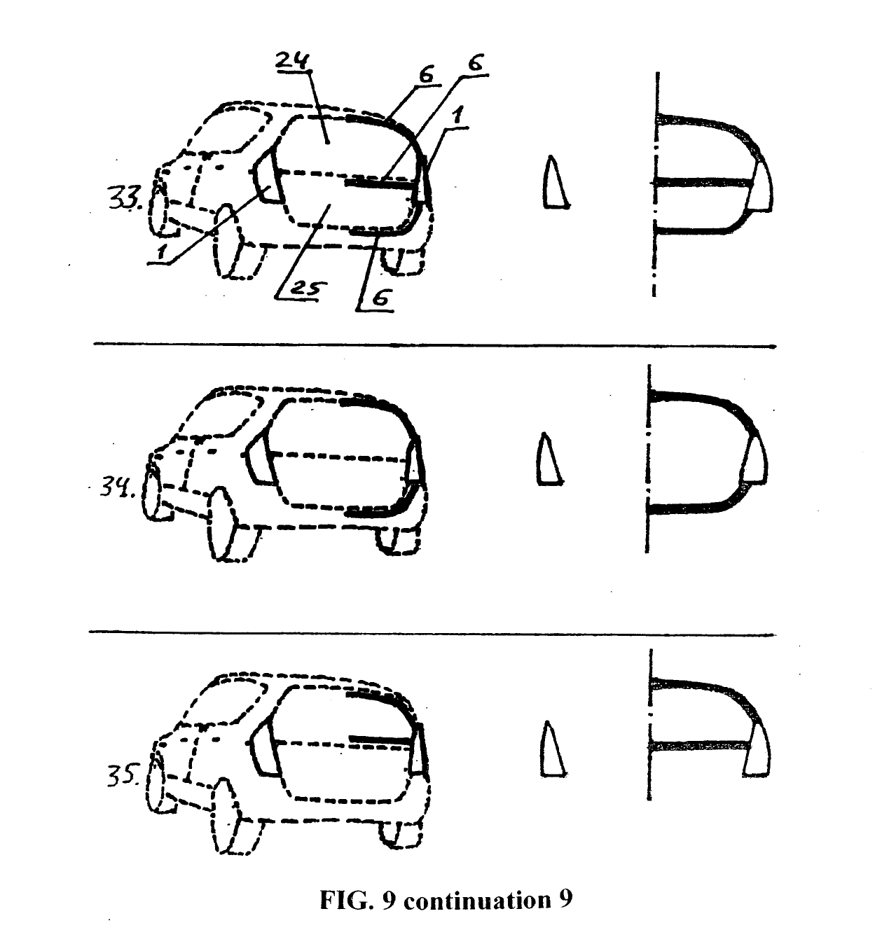

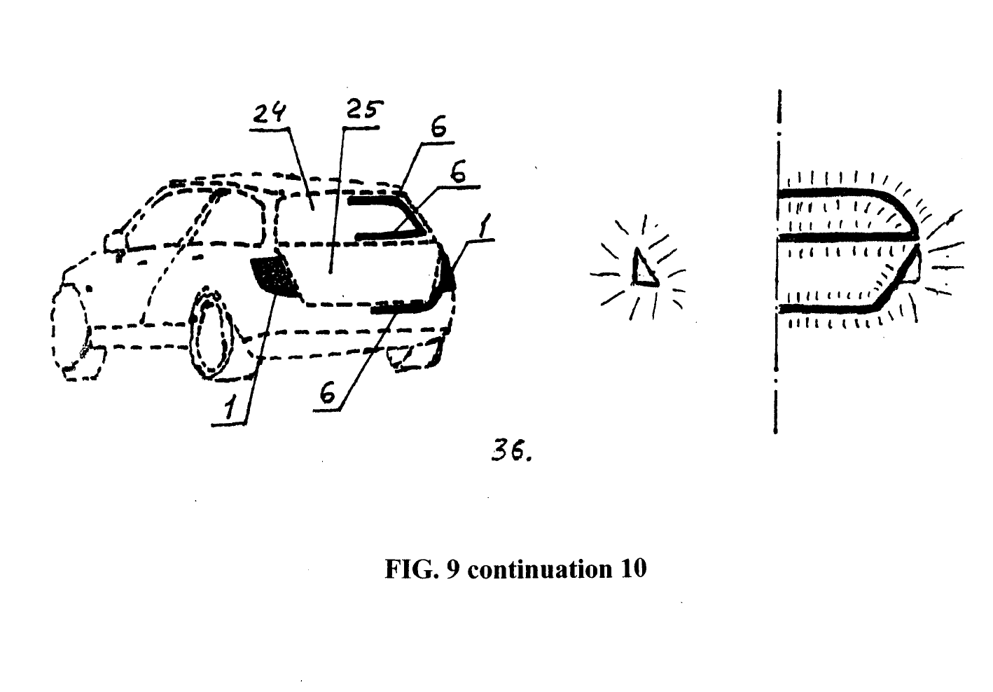

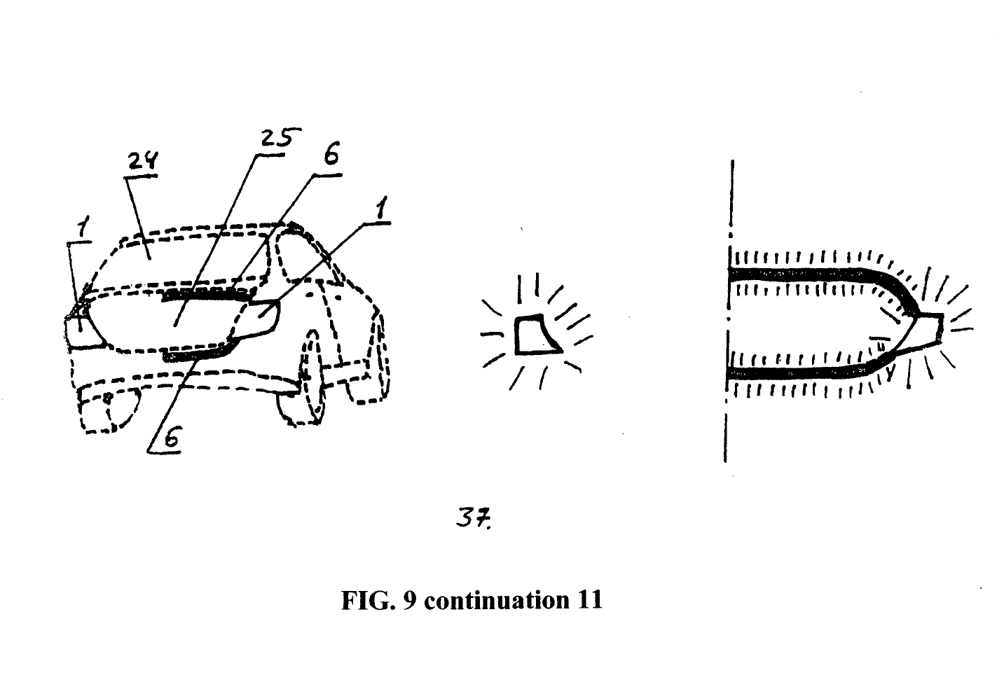

The realisation (embodiment) variants are possible, in which only one of the lightlines 6 (among others 6a-6z) is used; or all possible variants, where any combinations of these lightlines 6 (among others also combinations of lines 6a-6z) are used. The most probable combinations are presented in the FIG. 9. Nevertheless all other combinations of the lightlines 6 are also possible. The lightlines 6a-6z can a.o. be placed on the edge-lines (inflection/bend-lines) of the vehicle body surface, on the vehicle body surface near these (edge-, inflection-, bend-) lines, on edges, above or under the edge-lines of the moving parts (as £e. door 13, motor hood 14, etc.), anywhere on the vehicle's body surface, on- or behind the glasses (but not under the head lamps covers—s. above). Also the realisation (embodiment) variants are possible, where the right or left ends of the lightlines 6 do not adjoin the head lamps, back lamps, or other lighting.

The same arrow-kind lighting is placed on the back part of a vehicle the same way. Instead of the head lamps 1 one use here the back lamps (back lighting lamps) 1. Therefore, as it was already said above, mainly the front views are given in the drawings, because the back views are, in the subject meaning, the same. (The circumstance that the head lamps are normally round and white-lighting, and the back lamps (back lights) are normally quadrangular and red-lighting, does not play any subject role for the contents of the patent description).

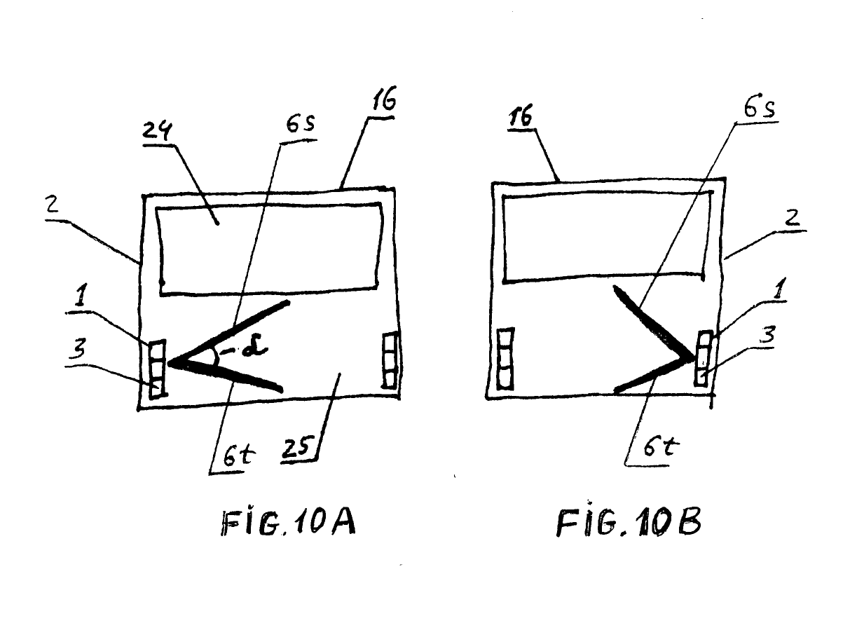

Nevertheless there is an essential difference: there are no air intake on the back side, and therefore one can place there the lightlines not only parallely, i.e. along the ribs of air intake, or outside the air intake surface, but also anywhere, with a free chosen angle α between these lightlines (FIG. 10A and FIG. 10B). Self evidently one can place the lightlines 6 under the angle on to another also on the front side of a vehicle as well also on the flank side of a vehicle, if the geometry of a vehicle body permits it.

The most probable realisation (embodiment) variants for the back view of a vehicle are shown in the FIG. 9, variants 33-37. A lightline 6 can a.o. first be placed under the laggage hood (or back door) 25, and then this lightline can embrace (surround) the all vehicle. Or this lightline can embrace the laggage hood (or back door). Or this lightline can embrace (surround) the back window, and to be placed either behind the window glass or on the vehicle body near the window, etc.—s. above.

The placed behind the window 24 (front window or back window or both) lightlines 6 can be used in the already produced vehicles as an additional equipment, i.e. without changing of a vehicle construction (design).

One can also switch on the lightlines 6 from the both sides of the axis of symmetry simultaneously to indicate a stop-intention. Such stop-intention indication can be used also instead of the presently existed stop-intention lighting. Nevertheless one can use such signal also additionally to the presently existing stop-lighting.

The presented in the drawings solutions can be also worded another way, namely, that one understands under the arrow-kind structure the such placing of lightlines 6, where the end points of these lightlines are separated one from another at the one side of these lightlines, and they are placed, among others, approximately (nearly) at the central axis line of symmetry of a car body, or near it; and the end points of these lightlines of the other sides of these lightlines are placed in one point, or nearby one to another, or the both lightlines are adjoin by their left or right end points correspondently to the left or right head lamp (or correspondently to one other kind of a left or right permanently (not blinking) shining lamps, among others, back lights). Whereby all arrow-forming lightlines are electrically switched-on to shine simultaneously on that side of a vehicle, whereto this vehicle executes the turn-indication.

The lightlines 6 can be both straight and curved.

One can see that in the majority of embodiments the head of the arrow-kind structure 7 (or every part of this head) looks approximately U-shaped (or π-shaped, bzw. V-shaped), where the letter U (or π, or V) is placed horizontally (i.e. 90° turned to the its usual writing), and the both ends of the a.m letters lay on the vertical axis of a vehicle.

The lightlines 6 can be placed on the body of a vehicle, a.o. also along a window of a vehicle, or on a window of a vehicle, or behind a window of a vehicle, or a.o. on the boundary between a window edge and vehicle's body edge. There can be, as said above, also a combined placing of lightlines 6 both behind a vehicle's window and on a vehicle's body.

The shown in the FIGS. 1-5 realisation (embodiment) variants of the invention can be worded also the following way:

The turn-intention of a vehicle 16 is indicated by a lightline 6, which one lays outside a head lamp 1 (or outside a head lamp transparent cover), whereby the both ends of this lighting line lay approximately on the axis of symmetry 20 of the front view (or back view) of this vehicle, and besides, embraces (surrounds, contains) this line the external contour (the silhouette 22) of this vehicle from that side of the axis of symmetry 20, whereto the turn-intention is intended and indicated. Where this lighting line can also embrace (surround) the external contour (silhouette) of only one part of this vehicle, also from that side of the axis of symmetry, whereto the turn-intention of the vehicle is intended and indicated. (One a.m. part of the vehicle is for example a radiator grill (grate) 23, front window (back window) 24, motor hood 14, laggage hood (or back door) 25, a lower part of a vehicle's body, which part lays under the front- and back windows, a geometrical peculiarity of a vehicle's body, as for example an inflection (bend)—line 27 of the motor hood surface, etc.). Besides, these lighting line cam be, a.o., also discontinuous, i.e. inside these lighting lines also the dark (i.e. not lighting) intervals can exist, or the intervals, where the other light sources (as f.e. the head lamps, the back lamps, etc.) lay.

Here it is meant, that the case in point is a line, which one is beginning and ending itself approximately on the a.m. axis of symmetry. Therewith, in this wording one understands it so, that the line groups, which form one line (as for example, a.o. the groups 6a&6b; 6i&6j&6h; 6l,&6m&6k; 6u&6v; etc.) present the one solely line, which consists of several parts, as for example, 6a&6b, etc.

In this description normally the lightlines only from one side of a vehicle are shown, and concretely for the case, when a vehicle have to show a turn-intention either on the left, or on the right. The possible variants for the turning in the opposite direction (i.e. on the right or on the left correspondently) are absolutely symmetrical and therefore these symmetrical variants are not shown.

All variants of placing of lightlines for the front view are also suitable for the back view, and vice versa. Therefore only one view is shown (either front view or back view of the vehicle) for every variant of placing of the lightlines.

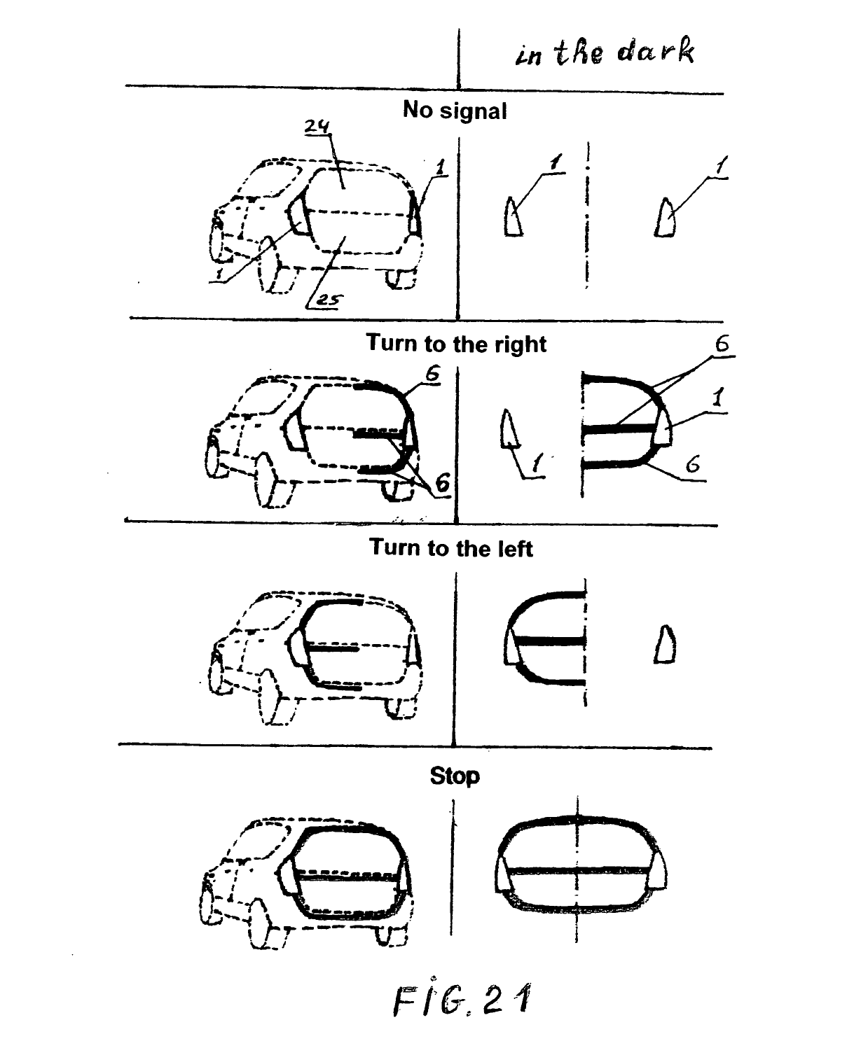

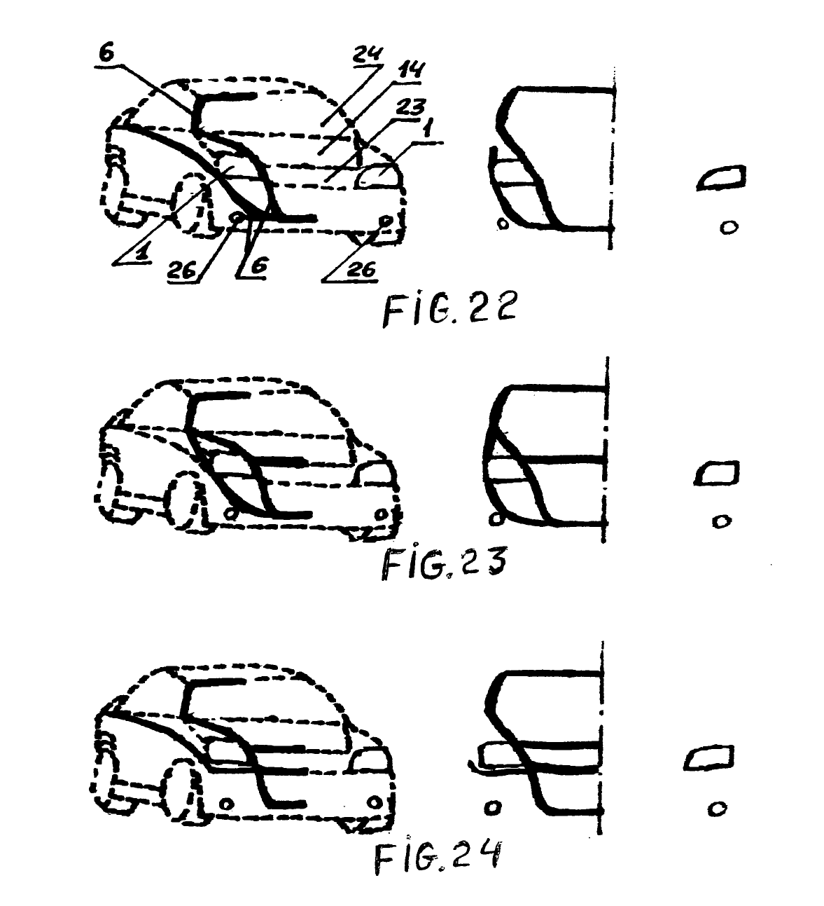

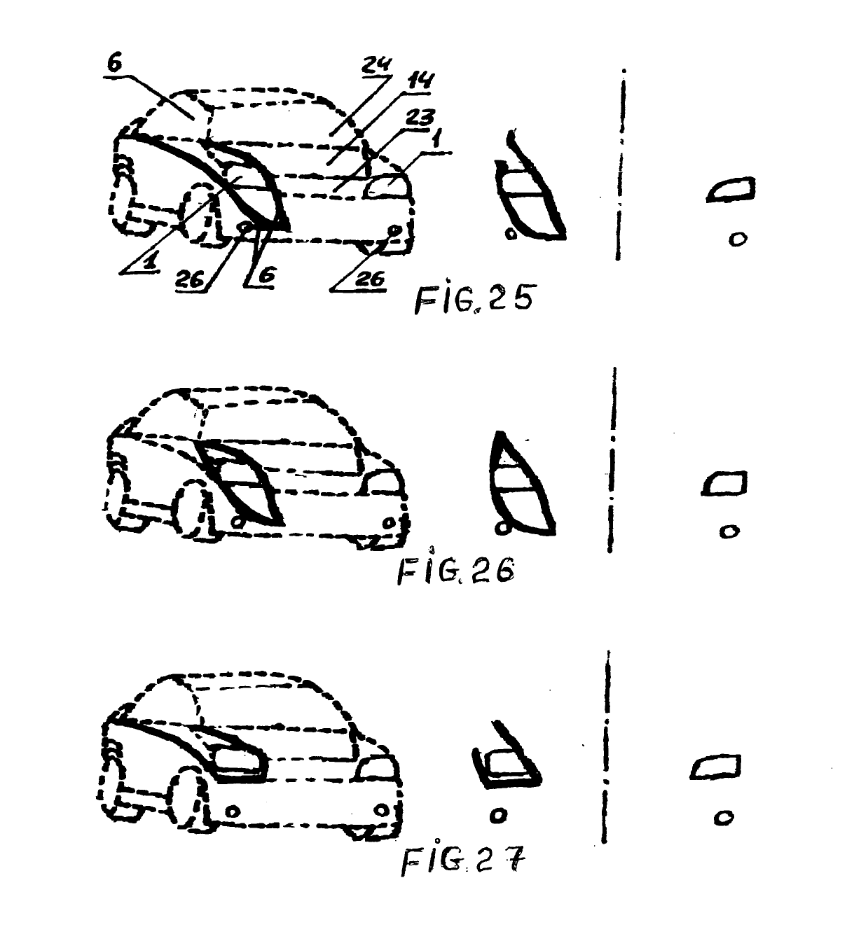

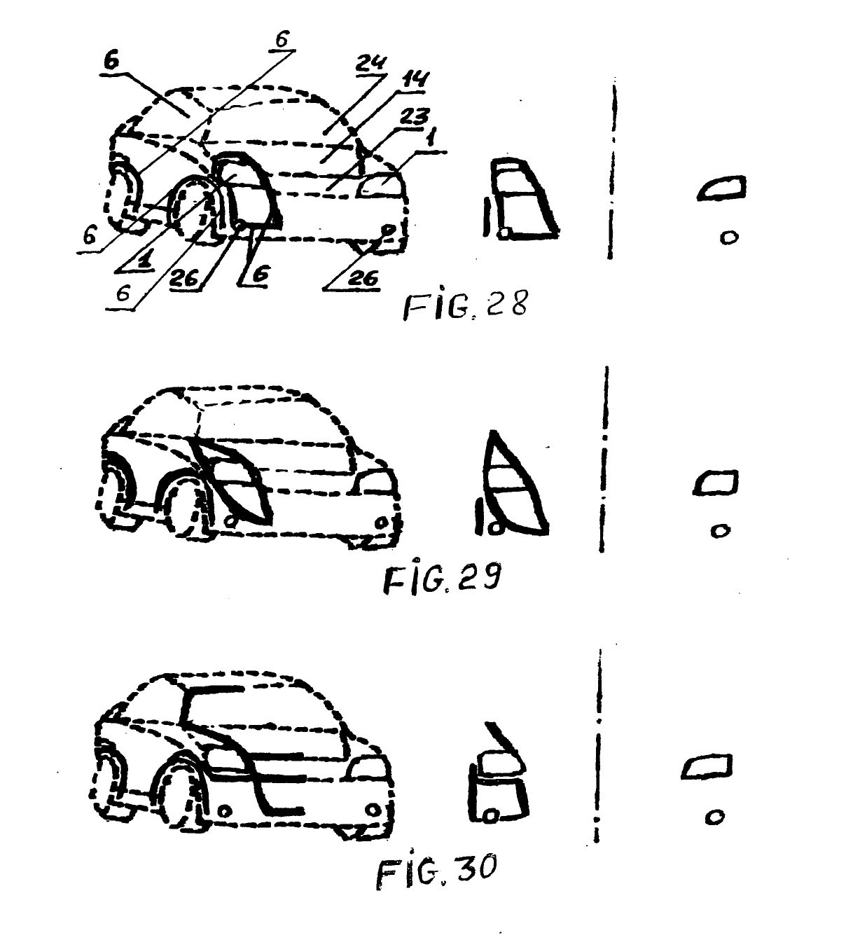

As it was already in general described, the lightlines 6 can also embrace (surround) some separate parts of the vehicle body, a.o. also head lamps, visual peculiarities of vehicle's body, as f.e. convexities (reliefs) or bends of the vehicle body, etc., where the a.m. lightlines 6 or some separate parts of the lightlines 6 can built (form) the closed curves (s. f.e. FIG. 22-FIG. 30).

Among other variants, the lightlines 6 can embrace (surround) some a.m. separate, big in comparison with the head lamps parts of the vehicle body (a.o. also the splash-boards/wings), but do not build (form) any closed curves, where, in some projections (f.e. from the front view) one can a.o. see visually the closed curves, or almost closed curves of lighting lines (it means that the lightlines can build (form) the closed or almost closed curves in some projections).

Furthermore, in the above described cases, the lightlines 6 can a.o. also be not connected with the axis of symmetry.

The lightlines 6 can a.o. also be placed on a splash-board/wing (s. f.e. FIG. 28-FIG. 30), or they can embrace (surround) the doors.

As it was already described, the lightlines 6 can embrace (surround) also the windows, and besides they can embrace (surround) not only the front windows and back windows, but also the flank windows. For these cases the all above described features are also valid, a.o. that these lightlines can be placed either behind the window or on the vehicle's body near the window, etc.—s. above.

One can describe it also such way, that a turn-intention signal (Blinker) is formed by the lightlines 6, which lightlines embrace (surround), completely or partially, a flank window.

The lightlines 6 can also consist of the lighting points or lighting intervals or other geometrical figures.

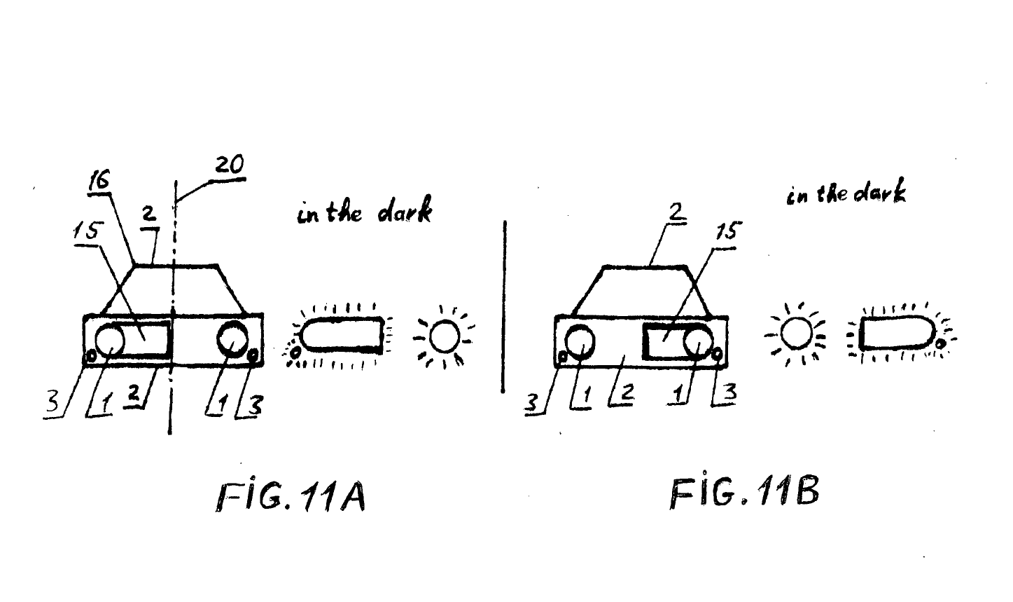

The lightlines 6 can also build (form) a wide lighting strip (band), which width is comparable with diameters of the head lamps 1 or back lighting 1h. Or, instead of the lightlines 6, one can build also a wide lighting strip (band) 15, the width of which is comparable with the diameters of the head lamps 1 or back lighting lamps 1h (FIG. 11A and FIG. 11B). In this case the case in point is a pair of wide strips (bands) 15, where the each of them adjoin itself by it's left or right end correspondently to the left or right head lamp 1 (or correspondently to one other kind of left or right permanently (not blinking) shining lighting, a.o. back lighting 1). And besides, these wide strips are blinking periodically, among other variants also synchron with the usual turn-intention lighting lamps together.

The strips (bands) 15 can be also both straight and curvilinear.

The embodiments also possible, where the whole vehicle's body 2 is blinking completely from the left or right side from the axis of symmetry 20. Or a part of the vehicle's body (a wide strip (band) is shining or blinking, which part lays between the axis of symmetry and external contour (silhouette) of the vehicle.

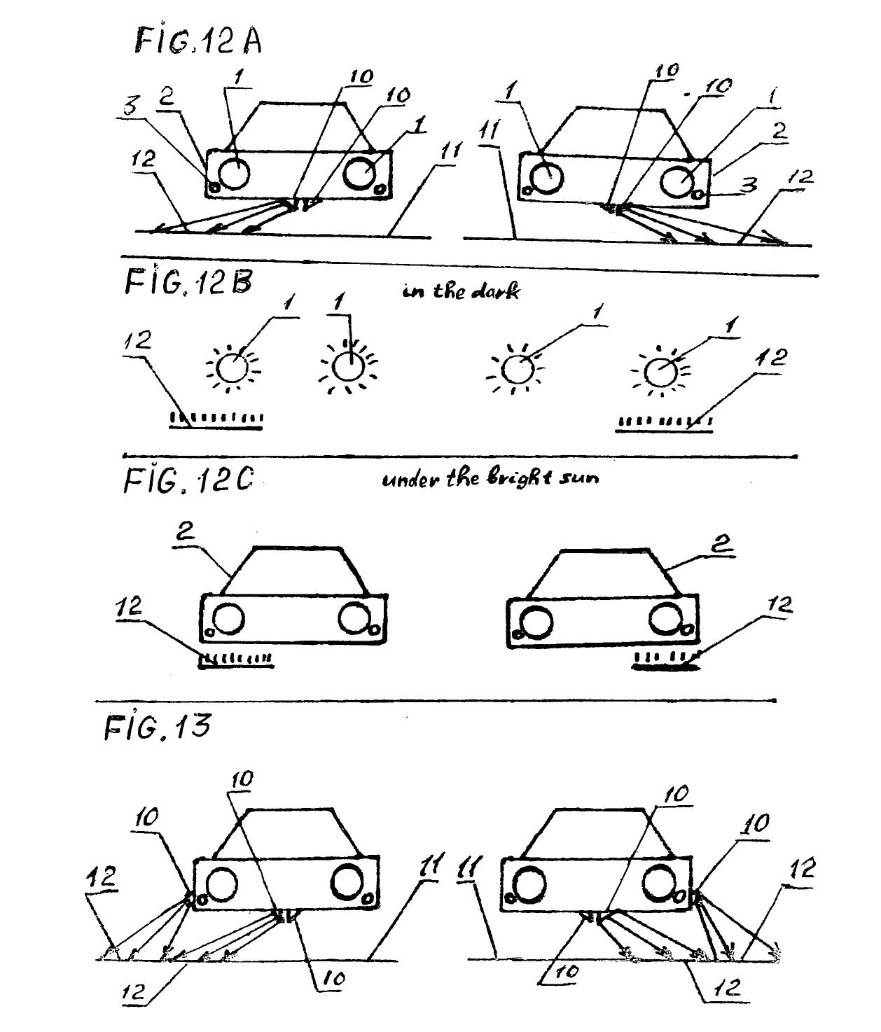

One next example of embodiment of invention is presented in the FIGS. 12(A-C)-19(A-C).

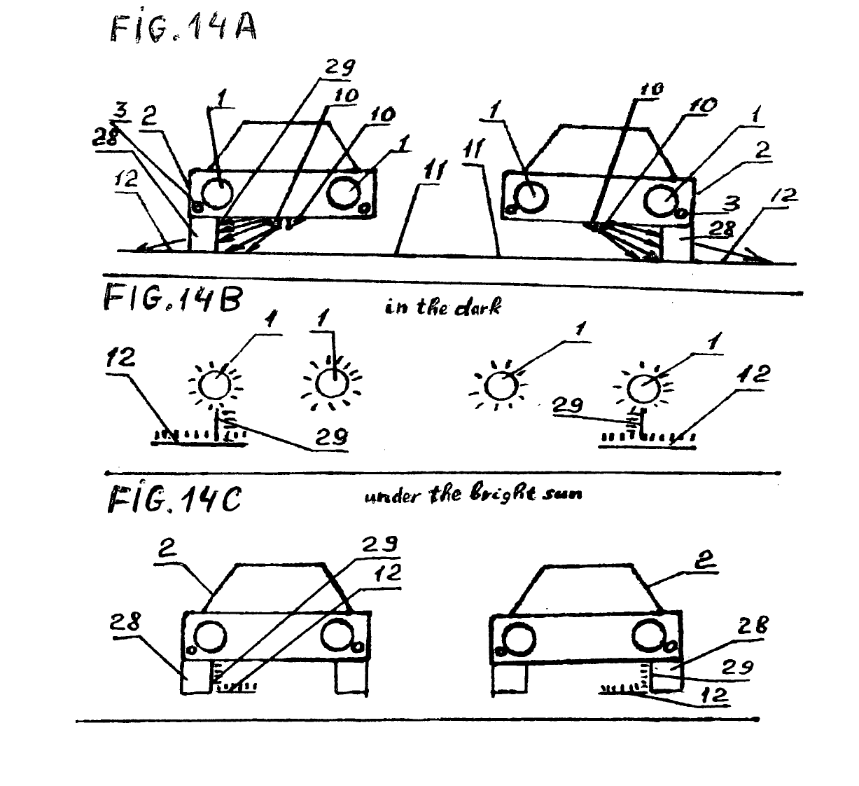

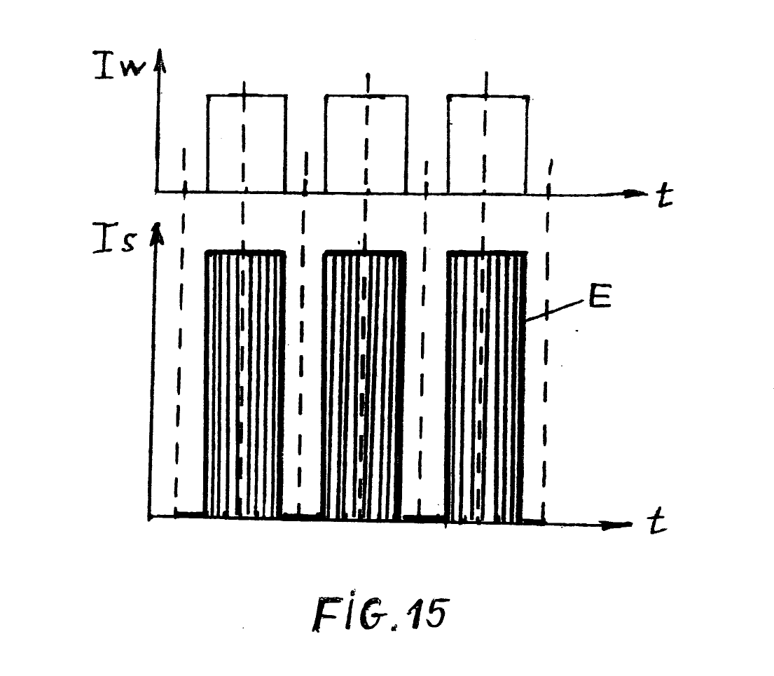

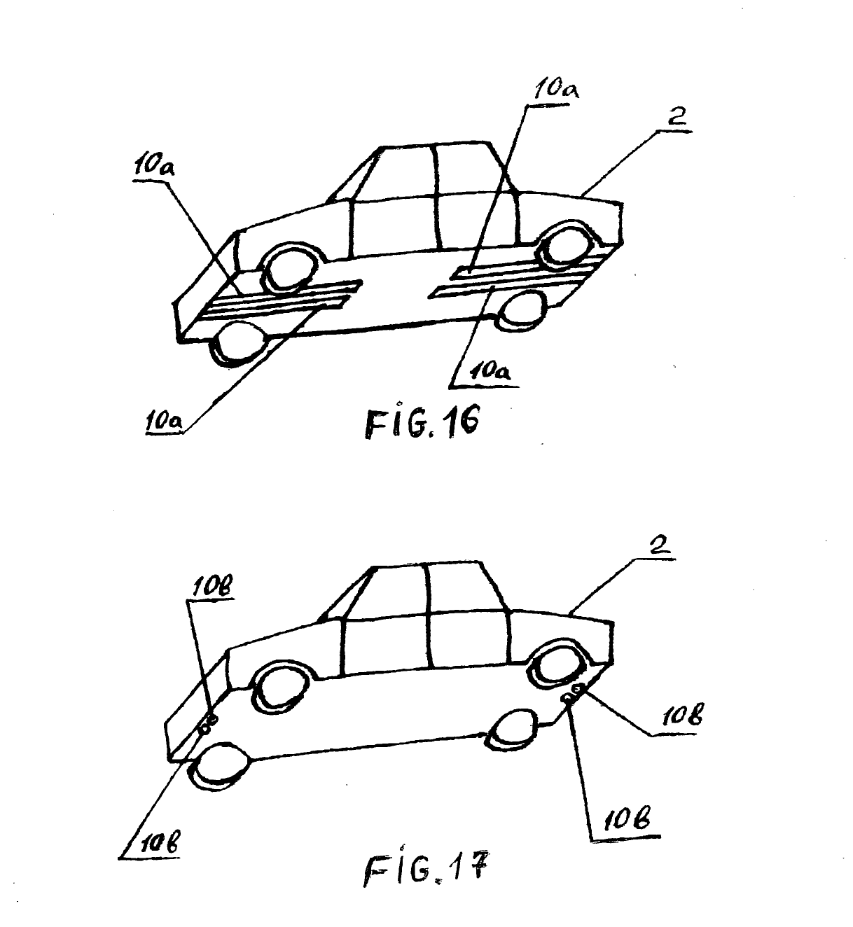

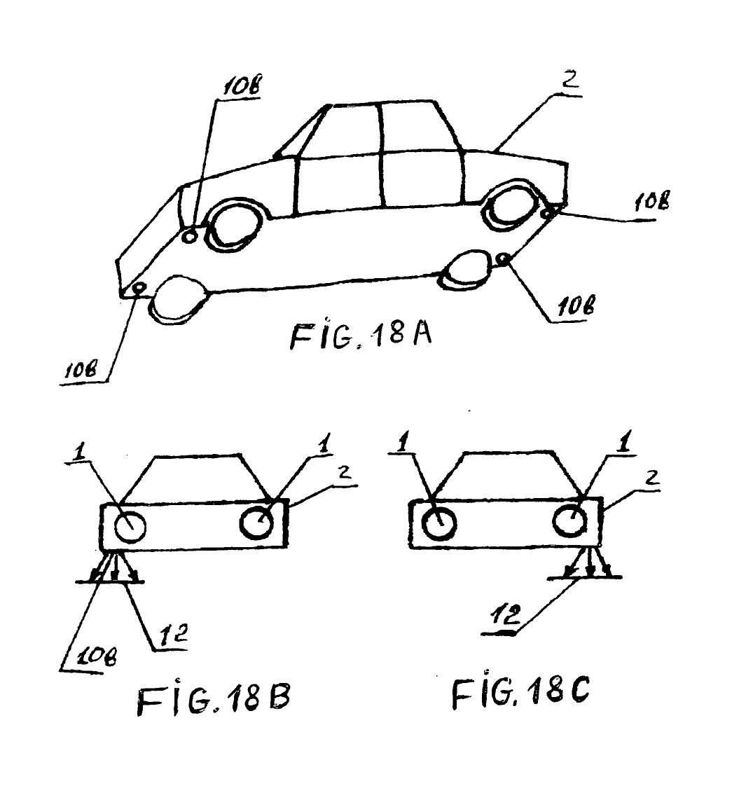

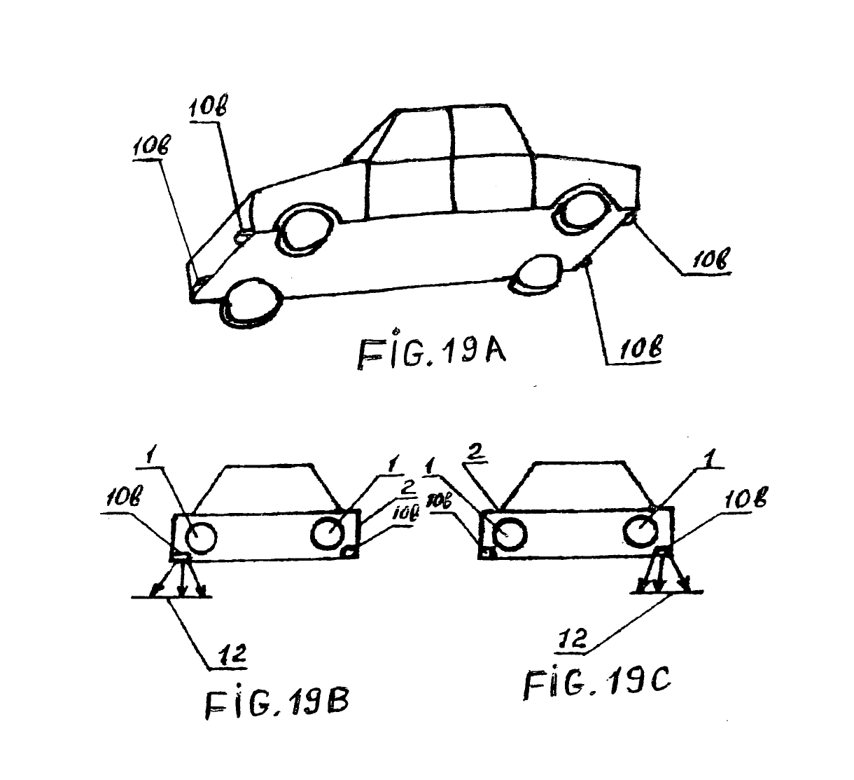

Both in the darkness and also under the shining sun, the part 11 of road surface (asphalt, ground surface etc.) immediately under the vehicle is the most dark place on & near the vehicle, because this surface part lays always in the shadow. (The shadow is caused either by day light (sunshine) or by night street lighting. Therefore one can equip a vehicle with the lights (beamers) 10, which lights 10 are shining (beaming) down (and which lights 10 are placed, among other variants, under a vehicle, or, a.o., on edges of a vehicle), and which lights 10 light up either the left or the right part of the road surface under the vehicle (and also a bit near the vehicle) correspondently to the direction of the turn-intention (FIG. 12(A-C)-FIG. 14(A-C), FIG. 16-FIG. 19(A-C)). These lights 10 can light up also the internal parts 29 of either left or right wheel of the vehicle, correspondently to the direction of a turn-intention (FIG. 14(A-C)). (Furthermore, self-evidently, one can light up not only the internal, but also the front parts of the a.m. correspondent wheels of a vehicle in the front side of the vehicle and the back parts of the a.m. correspondent wheels of the vehicle in the back side of the vehicle.) In contradiction to the usual lights 1, which may not dazzle a driver, who moves in the opposite direction, the lights 10 can be infinitely bright and strong-lighting. Also in contradiction to the head lamps 1 and to the other usual lighting of a vehicle, these lights 10 can be focused exactly on the determinate places of the surface 12 of the road under (as well as a bit near) the vehicle, or these lights 10 can shine parallel-straight-lighting. As this strong light-signal is focused on the surface of a road under- or directly near the vehicle (but it does not shine parallely to the road surface into the eyes of a driver of a vehicle, which moves in the opposite direction), there is no reasons to limit the intensity of the lighting.

The lights 10 can also blink, a.o. they can blink also synchron with the usual turn-indicating lights 3. Nevertheless the lights 10 can also blink sparkle/flash-kind (short blink time), where the every flash is high-bright and intensive-lighting. The blink frequency can be also higher, a.o. also much higher the frequency of the usual turn-intention lights (blinkers). The sparkle/flash-kind, also energy economizing, lighting techniques (or light-impulse techniques) is known a.o. from the airplane-building technologies, photocamera's producing technologies; the techniques for the multiple light flashes during a short time periods is also known from the phototechnologies, and therewith it belongs to the state of technology.

The light-flashing lights (lamps) can be also so electrically connected, that the each further series of quick-flashes is interrupted by a break (i.e dark time-period without light-beaming), where the time period of the flash-series is the same as the time period of switched-of state of a turn-intention indicator (blinker), and the time period of the a.m. break (dark pause) of the a.m. light-flashing lamp is the same as the time period of the not-lighting pause of the blinking turn-intention light, and besides the a.m. light-flashing lamp and the usual turn-intention lights are switched on and switched of synchron and simultaneously.

FIG. 15 shows some possible variants of synchronising between the light-flashing lamp (lighting) and usual turn-intention lighting in the same vehicle. Here “Iw” is the light intensity of a turn-intention lamp; “Is” is the light intensity of a light-flashing lamp, “t” is time, and “E” is the envelope curve.

As it is known, a human eye recognises the two, each after other in series happening light flashes as two different flashes only if the time period between these flashes is bigger then a definite known biologically determinated constant (in the future named as the “T_{eye}”). But if the a.m. time period is less then the a.m constant T_{eye}, recognises the human eye these a.m. two flashes as one flash.

Therefore the above described light-flashing lights (lamps) can be built or installed (electrically connected) such way, that the time periods between the solely separate flashes is less then the a.m. constant T_{eye}. In this case the street traffic members recognise the complete flash-series as one non-interrupted lighting.

Or vice versa, the above described light-flashing lights (lamps) can be built or installed (electrically connected) such way, that the time periods between the solely separate flashes are bigger then the a.m. constant T_{eye}. In this case the members of street traffic recognise also the separate flashes.

The second a.m. working regime provides more recognisable indicating, which one can be used in the extraordinary bright surrounding (f.e. under the intensively shining sun). The first a.m. working regime provides a less aggressive indicating.

The light-flashing lights (lamps) 10 can consist both of lamps (or other point-kind sources of light, a.o. circle, square, quadrangle, triangle, etc.) 10b, and of schining strips (bands) 10a, which are placed under the vehicle's body 2.

Such way one use the lights 10 as the turn-indicating lighting.

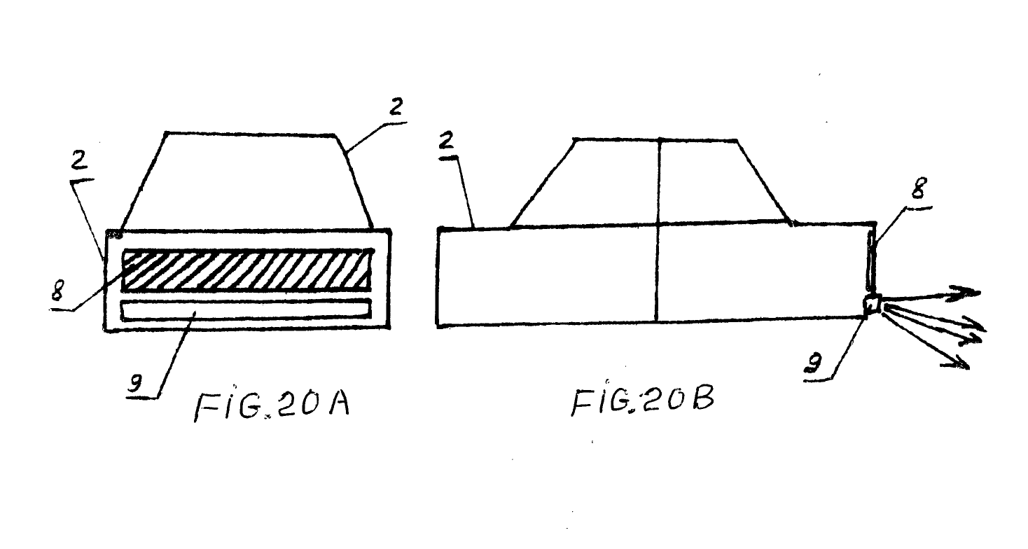

Besides, instead of the two lamps 1, which are place on the both sides of the vehicle body (and on the both sides of the surface of the radiator opening 8), the usual head lamps 1 themselves can consist of one shining strip (band) 9, which strip (band) is placed under the surface of the radiator opening 8, and which strip (band) takes place from the left to the right boundary of the front side. Therewith one can reduce the dazzling effect for a driver, who moves in the opposite direction (FIG. 20A and FIG. 20B).

One can also use the above-described turn-intention lighting (both the lightlines 6—kind lighting, and the turn-intention light-flash 10—kind lighting) for the “Stop”- and “Furthermoving”-manoeuvre indication. For this aim one switch on simultaneously the both turn-intention lighting, which are placed from both the left and right side of the plane of symmetry 21.

As an example, one example of embodiment is presented in the FIG. 21. To indicate a stop-intention, one switch on simultaneously the lightlines 6, which are placed on the right- and left-side of the axis of symmetry 20 (FIG. 21). When the vehicle is going to move again, one switch off simultaneously the both lightlines. Furthermore, the lightlines 6 can shine a.o. blinking way in the turn-intention mode, but in the stop-indication-mode (i.e. when the lights a switched off simultaneously) these lights can shine a.o. permanently (not blinking way). Wie ist es oben bereits gesagt, alle möglichen Variationen der Konfigurationen der Leuchtlinien 6 sind möglich. Für die Stop-Indizierung müssen aber alle Leuchtlinien 6 an der Karosserie beidseitig (d.h. symmetrisch in Hinsicht auf die Symmetrieachse 20) leuchten.

In the first embodiments one can use the traditional lamp-kind (point-kind) turn-intention lights (lighting lamps) 3, which one do not belong to the above-mentioned arrow-kind structure, also together and simultaneously with the lightlines 6. But one can use the lightlines 6 also instead of the lighting lamps 3, because these lighting lamps 3 are much less recognisable and therewith they are surplus (not necessary). Therewith the case in point are both the additional turn-intention lighting indicators and also the alternative turn-intention lighting indicators. If in some separate countries the legal rules exist to use the existing constructions of “Stop”- and “Turn-intention”-lighting, they can be used simultaneously with the above described “Turn”- and “Stop”-signals.

The turn-intention indicators, both according to this description, and also all traditional turn-intention lightings, can be built as the lighting with the possibility to regulate (control) the brightness of this lighting.

Besides, a vehicle contains also:
a devise (devices) for measurement of brightness, with which device the measuring of brightness of the head lamps, vehicle's body and brightness of surrounding can be executed;
means for calculations (computer, chip, etc.); and
a device (means), which change the brightness of the turn-intention lighting.

The above mentioned device for the brightness measuring transfers the actual dates to the a.m. means for calculations. These means for calculation calculate the optimal for a human eye intensity of light of turn-intention lighting (as well as of stop-signal lighting) and gives the command to the a.m. device to change the brightness of the turn-intention lighting (as well as stop-lighting). The same way one can also regulate (control) the brightness intensity of the head lamps, as well as always realise an optimal ratio between the brightness intensity of head lamps and turn-intention lights (as well as stop-signal lights).

As it was already shown above, one can indicate the turn-intentions of a vehicle through the lighting up of the correspondent (left or right) wheels of a vehicle. In this case the vehicle's wheels reflect a “light-irradiation from outside”. Nevertheless one can indicate the turn-intentions of a vehicle such way, that the vehicle's wheels have the sources of light themselves, i.e. the turn-intention lighting is placed on the vehicle's wheels or in the vehicle's wheels.

The turn-intention lighting 30 can be placed also on the upper parallely laggage splints 31 (FIG. 31A and FIG. 31B). These splints for the laggage carrying are oftly placed on the upper part of a vehicle's body 2.

One can place the turn-intention-lighting 32 also on two rods (supports) 33, where these rods 33 are placed on the upper part of the vehicle's body 2 (FIG. 32A and FIG. 32B). Nevertheless such placing could be suitable only if these rods 33 execute simultaneously also some other functions. And concretely:

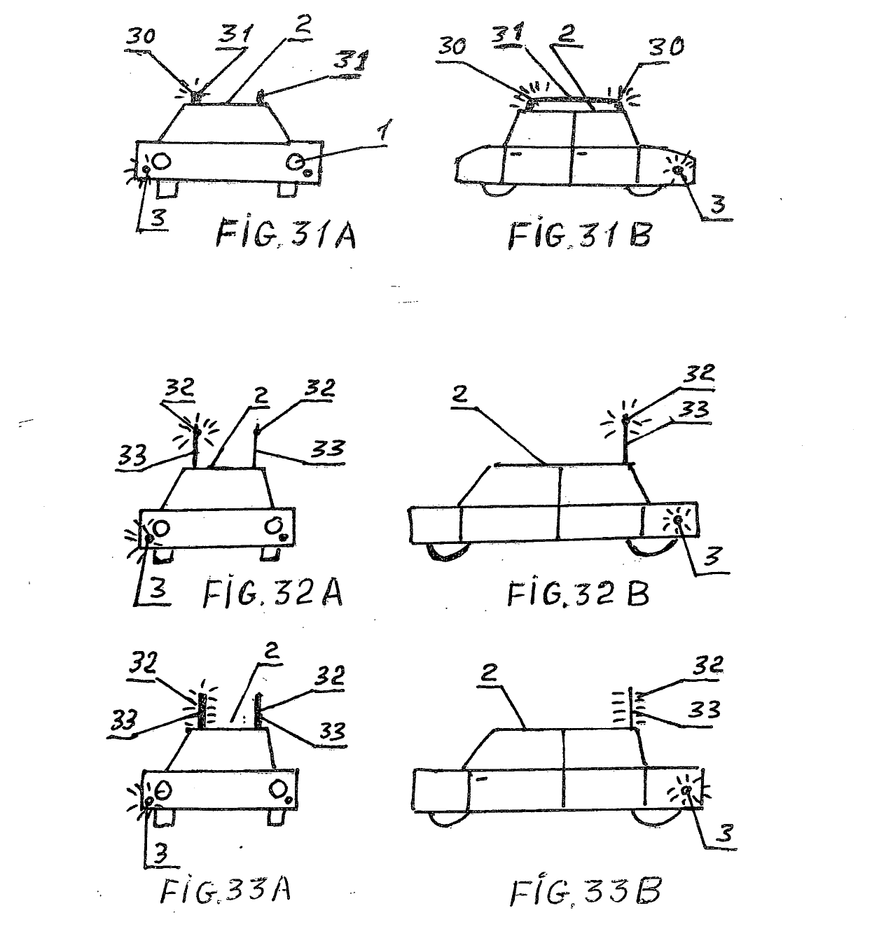

1) The rods 33, or at least one of them, can execute a role of an antenna. In the old models of vehicles one used two antennas, where the each of them was placed on the vehicle's body from the right or left side. Now one used only one antenna, which one placed centrally on a vehicle's body. But one can use two antennas again, where the rods 33 could execute the both functions (antenna and carrier of a turn-intention lighting).
2) The rods 33, or at least one of them, can also execute a role of a video-scout (vehicle's periscope)—(FIG. 34(A & B)-FIG. 36). As a driver sits in a vehicle, he can observe the traffic situation from his position only limited. In particular. He can see only the immediate next nearest vehicle in front of him and behind him. A driver does not see the 2-nd, third, firth, etc. vehicles, which move in the line before him and behind him. The using of videocamera for the aims of vehicle's orientation is known. But these videocameras are placed directly on a vehicle's body. Therewith such cameras provide the views only to the immediate nearby moving vehicles. If one places a camera 34 on the upper top of the rod 33, which rod is placed on the vehicles body 2, and which a.m. upper top stays above the vehicle, the driver will be able to observe visually also the situation with the a.m. 2-nd, third, firth, etc. vehicles before and behind of him in the line. This camera 34 can be placed, self-evidently only on a long enough rod (support) 33. One (solely) rod 33 can be placed on the vehicle's body centrally, or it can be placed on one side of the body, (optimally from that side, where the driver sits—it can be on the left or on the right side). Nevertheless if one places the cameras 34 on two rods 33, one can see not only the further vehicles in the line, but also make measurements of the related distances. Therewith the information from the cameras 34 can be transferred not immediately to a display, but firstly to the computer, and after that this traffic situation will be presented on display, among other variants also in a form of computer simulation. The a.m. system, which contains the rods 33, cameras 34, vehicle's computer, can also contain an additional device (means), which compensates the occasional deviations from the vertical axis or vibrations of the camera 34 (among others compensates electronically). This function can be executed also by a vehicle's computer with the correspondent software. Under the “vehicle's computer” one understands also a board-computer, a microchip, or any other electronic device, by which the electronical signals from the videocamera can be processed.

The langs or (and) angular position of the rod (the rods, in the future—“the rods”) 33 can be also adjustable.

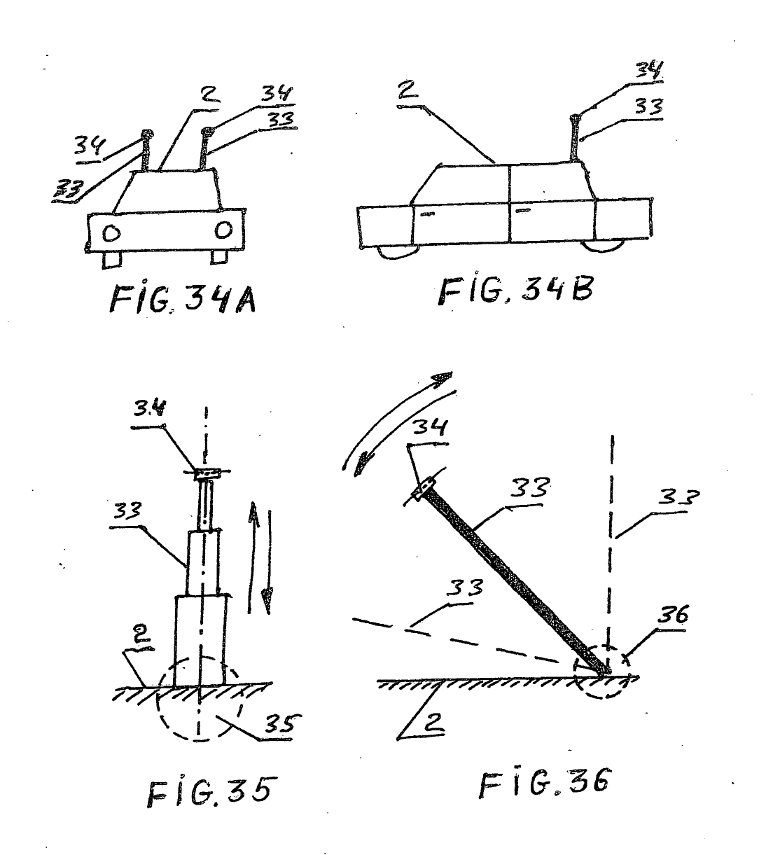

The rod 33 can be executed as a telescopic one, and also contain a mechanism 35 (a.o. an electro-mechanical mechanism), by which this rod can be repositioned for the definite length by a driver during a trip (FIG. 35).

A.o. the rod 33 can be adjustable also for different angles or orientations in respect to the vehicle's body, and for this aim this rod can contain the correspondent mechanisms 36, a.o. the electro-mechanical mechanisms (FIG. 36).

Each rod 33 can also have two cameras, where one of these cameras is orientated forwardly (forward view), and the second is orientated on the back (back view).

Self-evidently one can use these a.m. rods 33 with the videocameras 34 as video-scouts (“vehicle's periscopes”) also separately and independently from the turn-intention indication. Nevertheless if the rod 33 is used also as a turn-indicator, the turn-indication lights 32, can be placed on the rod 33 both as the point-kind lights (FIG. 32A and FIG. 32B) and as the linelights (FIG. 33A and FIG. 33B).

The videocameras 34 in connection with a vehicle's computer can recognise a.o. also the turn-intention lights of the ahead- back- or nearby moving vehicles (and therewith the turn-intentions of these vehicles), and to inform the driver about it (through display, a.o. also through the simulating vehicle's contours on display, or through any other light-kind, acoustic-kind or any other informating signals).

Therewith the driver can be informed about the turn-intentions not only immediate nearby moving vehicles, but also about the turn-intentions of the 2-nd, third, fourth, etc. vehicle in the vehicle line.

The videocameras 34 in connection with the vehicle's computer can recognise a.o. also the stop-signal lights of the ahead-, back-, or nearby-moving vehicles (and therewith the stop-intentions of these vehicles) and to inform timely the driver about it.

The rods 33, or at least one of them can also simultaneously all three roles/functions of: a) carrier of the turn-intention lighting, b) antenna, and c) a.m. video-scout (vehicle's periscope).

Each videocamera 34 is equipped with a device, which one provides the horizontal placing of the camera, also when the rod 33 has an angle with the vehicle's body. These devises are known (f.e. the parallelogram-based constructions with sharniers) and belong to the state of technology.

The turn-intention indication of a vehicle, as well as the stop-indication, can be executed also through the light signals, which can be generated on some distance from the vehicle or from it's material technical parts (as f.e. vehicle's body, back-view mirror, etc.). It means that one see a light signal “in the air” near the vehicle, not immediately on it's body or on it's parts. These technologies are already used in other technical branches, as f.e. laser-show, or in computer-monitors-production or TV technologies (in tablet PCs, smartphones etc., which technologies are also known under the name “3D”-technologies, a.o. one need in some cases also the special glasses), and therewith these technologies are known and belong to the state of technology.

In the future these a.m. “in the air hanging” turn-intention lights and stop-indication lights will be named as the “virtual-image indication lights.
Among other variants (below “a.o.”) these “virtual-image indication lights” can be generated by laser irradiation, where the source-device (devices) for this radiation is placed on- or in- or behind the vehicle's body.
A.o. these “virtual-image indication lights” are generated by at least two sources of laser radiation, which are placed a.o. on-, or in-, or behind the vehicle's body.
A.o. these “virtual-image indication lights” are presented as a hologram.
A.o. these “virtual-image indication lights” can be also generated as a result of a reflection (visualisiring) of a light beam (or several light beams) in one space through the a) dispersed liquid drops, a.o. water drops, b) with the vapor, a.o. condensations steam, or c) with any other gas-like substance, which one contains a lot of reflecting points. In this case the vehicle contains (on the vehicle's body near the turn-intention lighting source) an injector, by which injector the a.m. dispersed drops of liquid or vapor are shooted from the vehicle's body such way, that the a.m turn-indicating beam beams through the space with these a.m. liquid drops or vapor. This last variant, which requires the using of liquid drops, can be nevertheless practically efficiently used only in solely special cases.
A.o., instead (or additionally to) the lamp-kind blinkers, these back-view mirrors can contain the devices (means), which can generate the a.m. “virtual-image indication lights”, a.o. the 3D-visual image, outside the mirror body or outside the vehicle's body. This way the turn-intention can be indicated through this virtual-image, a.o. in the form of a “hanging in the air” arrow.

What is claimed is:

1. Method of indicating of turn-intention of a vehicle, where, on a vehicle body, additionally to the permanently (not blinking) shining head lamp or additionally to the back lights, a left- or right-placed light is switched on, shortly for turn-maneuvering,
where a left- or right-orientated arrow-kind lighting structure is formed, which structure consists of at least two lighting lines (or strips or bands, named in the future as “lightlines” or “lighting lines”), where the end points of these lightlines are separated one from another at the one side of these lightlines, and they are placed, among others, approximately (nearly) at the central axis line of symmetry of a car body, or near it; and the end points of these lightlines of the other sides of these lightlines are placed in one point, or nearby one to another, or the both lightlines are adjoin by their left or right end points correspondently to the left or right head lamp (or correspondently to one other kind of a left or right permanently (not blinking) shining lamps, among others, back lights), whereby these lightlines are blinking periodically, among others also synchron with the usual turn-indicating blinking lamps (Blinker) together (simultaneously).

2. Method according to claim 1, whereby a turn-intention of a vehicle is indicated by a lighting line, which one lays outside a had lamp (or outside a head lamp transparent cover), where the both ends of these lighting lines lay nearly (approximately) at the axis of symmetry of the front view (or back view) of this vehicle, and besides, this lighting line embraces (contains) the external contour (outline, profile) of this vehicle from that side of the axis of symmetry, whereto the turn intention is intended and indicated; and whereby a.o. can this lighting line embrace an external contour (outline, profile) of only one or several separate parts of this car body (as for example radiator grill (Kühlerdeckungsgitter), head window (backwindow), motor hood (Motorhaube), laggage hood, etc.), also from that side of the axis of symmetry, whereto the turn-intention is supposed and indicated, whereby can these lighting lines be also discontinuous.

3. Method according to claim 1, where a turn-intention of a vehicle is indicated by an arrow-kind lighting structure, which one is orientated on-left or on-right, where this arrow-kind structure consists from two parts, which parts will be in the future named as a “head-part” and “foot-part”, where the head-part contains among others (a.o.) the lighting lines, which are lighting (also blinking lighting) from that side of the plane of symmetry of a vehicle, whereto the turn-intention of the vehicle is intended and indicated; and besides, contains the foot-part a.o. 1) a permanent (not-blinking) lighting “foot” of the arrow-kind lighting structure, i.e. a head lamp, (or also other permanent (not blinking) lighting light sources), which are lighting permanent (not blinking) on the car body on the opposite side of the above mentioned plane of symmetry; and 2) a dark gap between the a.m. “foot” and the axis of symmetry of a vehicle on the front view (back view) of the vehicle.

4. Device for executing of a method according to claim 1, where the device contains an arrow-kind lighting structure, which structure consists of two head lamps or two back light-lamps and at least one pare of lightlines, where the left or, correspondently, the right endpoints of the both lightlines adjoin correspondently to the left or right head lamp (or correspondently to the any other kind of left or right lights, a.o. back lights; or correspondently to the left or right contour (outline) of a vehicle; or correspondently to the left or right contour (outline) of a part of a vehicle), where the each of the a.m. lightlines adjoin itself with its other (i.e. right or left endpoint correspondently) in some point to the axis of symmetry of a vehicle.

5. Device for indicating of a turn-intention of a vehicle, which one contains at least one pare of the blinking turn-lights, where either one or other from them is blinking by a turn-manoeuvre, and this way indicates the correspondent turn-intention, whereby the turn-lights are made in the form of a flashing (sparkling) light (lamp), a.o. also oftly (flashing) sparking light (lamp), with the possibility to light up (illuminate) the part of surface of the road, which one is under the vehicle, as well as also with the possibility to light up the vehicles wheels, in particular the internal sides of these wheels, where these a.m. turn-lights are placed under the vehicle, or on edges of a vehicle, or on/in the wheels, where the beams of this turn-light is focused either on the left or on the right (dependently on the turn-intention direction) part of the above mentioned part of the surface of the road or directed thereto, or these beams are formed as parallel-formed beams, besides these a.m. turn-lights are produced a.o. as the point-lights or stripe-lights.

6. Device according to claim 5, where the flashing (sparkling) light on claim 5 is electrically switched on such way, that every future series of the quick-flashes (quick-sparks) is interrupted with a still-pause (i.e. no-lightbeaming), where the time period of a flash-series is the same as the time period of the lighting state of an usual turn-lamp indicator, and the time-period of an a.m. calm-pause of an a.m. flash-lamp is the same as the time-period of a calm-pause of an usual blinking turn-intention lamp, and besides, the a.m. flash-lamp beamer and the usual turn-intention lamp of the same vehicle are switched on and switched off synchron and simultaneously.

7. Device according to claim 5, where the turn-lights are generated by a laser.

8. Device according to claim 4, where the turn-lights are generated by a laser.

9. Method according to claim 1, where a maneuver lighting is switched on at the back part of the vehicle body shortly for the maneuvering, where the a.m. lightlines are switched on simultaneously on the both sides of the vehicle body (i.e. symmetrically in respect to the axis of symmetry of the vehicle) to indicate the stop-intention, where the a.m. lightlines are lighting during the stop-maneuvering a.o. in the permanent, i.e. not-blinking regime.

10. Device according to claim 5, where a maneuver lighting is switched on at the back part of the vehicle body shortly for the maneuvering, where the a.m. flash (spark)-lights are switched on simultaneously on the both sides of the vehicle body (i.e. symmetrically in respect to the axis of symmetry of the vehicle) to indicate the stop-intention, where the a.m. lightlines are lighting during the stop-maneuvering a.o. in the calm-pause-less regime.

11. Device for investigating (scouting) of the turn-intentions, stop-intentions, maneuvering of the vehicles, which are outside of the direct vision sector of the vehicle driver as well for scouting the position of the vehicles, situation on the road outside the direct vision of the vehicle driver for the determination of the maneuvering, a.o. overtaking possibilities, which device (vehicles periscope) contains
Videocamera (videocameras)
adjustable, a.o. sliding, a.o. telescopic, support for videocamera (videocameras), which support can put the videocamera in position above the vehicle body so high, that positions of other vehicles ahead or back of the vehicles on the road are visible;
mechanism (motor) to adjust (sliding) the a.m. support;
device to control the a.m. mechanism;
device to fix, a.o. to fix removably, the a.m. mechanism for support adjusting, electronic device to process the videosignal from camera and present it on the display of the vehicle;
electronic device to process and remove the image oscillations (swing, deviations) from the camera & display system as a consequence of the camera oscillations (swing, deviations) on the a.m. support;

12. Device according to claim 11, where at least two devices on claim 11 are used to determine precisely the position of other vehicles on the road.

13. Device according to claim 11, where an a.m. adjustable support for videocamera is placed either in the upper part of a vehicle body (a.o. on the level of the laggage splints), or in the middle part of the vehicle body (a.o. on the level of a back-view mirror), or inside the carrier for a back-view mirror (inside the back-view mirror).
